(19) United States
(12) Patent Application Publication
(10) Pub. No.: US 2012/0116993 A1
(43) Pub. Date: May 10, 2012

(54) INVESTMENT MANAGEMENT SYSTEM AND METHOD

(75) Inventors: Kenneth Joseph Ouimet, Scottsdale, AZ (US); Eric George Nichol, Carmichael, CA (US); Timothy Luke Ouimet, Scottsdale, AZ (US)

(73) Assignee: MYWORLD INVESTING, INC., Scottsdale, AZ (US)

(21) Appl. No.: 12/943,773

(22) Filed: Nov. 10, 2010

(51) Int. Cl. G06Q 40/00

(52) U.S. Cl. 705/36 R

(57) ABSTRACT

Investment management systems and methods are disclosed that solve an objective function subject to certain investment constraints to calculate a set of assets for an investment portfolio. In certain embodiments, the systems and methods comprise selecting from a plurality of assets a set of assets that improves net expected returns over a current set of assets in a portfolio. The systems and methods use asset-asset interaction decoupling techniques to eliminate matrix-inversion programming. In certain embodiments, with a function comprising net expected returns of the assets, a portfolio constraint, and a Lagrange multiplier, one or more correlations between assets can be removed such that each asset can be processed independently of other assets.

### BACKGROUND

1. Field

This disclosure relates in general to asset and investment management and more particularly to a system and method that improves the management of a financial portfolio.

2. Description of the Related Art

Modern Portfolio Theory (MPT), also known as Mean-Variance Optimization and Markowitz Portfolio Optimization, is an important and influential economic theory dealing with finance and investment. MPT is based on the premise that investors are risk averse: given two assets that offer the same expected return, investors will prefer the less risky one. MPT also teaches that it is not enough to look at the expected risk and return of one particular stock. By investing in more than one asset, an investor can reap the benefits of diversification, namely, a reduction in the overall riskiness of the portfolio.

MPT is usually represented by a quadratic objective function that can be solved to present an investor with a set of assets with a net expected return greater than any other set of assets with the same or lesser risk, and lesser risk than any other set of assets with the same or greater net expected return.

The inputs to the objective function commonly include the expected return for each asset, the standard deviation for each asset, and a correlation matrix between these assets. The expected return is the “mean” of mean-variance optimization. The standard deviation is a measure of risk. The square of the standard deviation is the “variance” of mean-variance optimization. Correlation is the degree to which different assets move in the same direction. When different assets move in the same direction a great deal of the time, there is a high degree of correlation. When different assets do not move in the same direction as each other, there is a low degree of correlation.

MPT has had a marked impact on how investors perceive risk, return, and portfolio management The theory demonstrates that portfolio diversification can reduce investment risk, and modern money managers routinely follow its precepts.

However, MPT is characterized by a number of significant drawbacks. One drawback is that the number of calculations required to solve the objective function increases non-linearly as a function of the number of available assets, and investment constraints add a layer of complexity. For example, a set of one thousand assets can require one billion calculations to solve the objective function when the objective function is subject to certain linear constraints.

Researchers have previously proposed various linear programming solutions to the MPT problem. However, these solutions comprise matrix-inversion programming, and they do not solve the scalability problem. In recent years, there has been huge growth in the number of different assets available to investors. The increase in the number of available assets is outpacing improvements in the processing speed of computers. Consequently, the lack of scalability of the matrix inversion puts MPT outside the reach of most investors.

### SUMMARY

In various embodiments disclosed herein, investment management systems and methods are disclosed that solve an objective function subject to certain investment constraints to calculate a set of assets for an investment portfolio. In certain embodiments, the systems and methods comprise selecting from a plurality of assets a set of assets that improves net expected returns over a current set of assets in a portfolio. The systems and methods use asset-asset interaction decoupling to eliminate matrix-inversion programming. In certain embodiments, the systems and methods disclosed herein improve the speed to reach a solution by performing a pre-test to ascertain whether any set of assets will satisfy investor constraints.

In one embodiment, a method is provided of determining an allocation of assets in a financial portfolio selected from a plurality of assets available to buy or sell. The method comprises receiving a portfolio constraint comprising at least one limitation on the extent that assets can be allocated in the portfolio. With a function comprising net expected returns of the assets, the portfolio constraint, and a Lagrange multiplier, one or more correlations between assets in the plurality of assets are removed such that each asset can be processed independently of other assets in the plurality of assets. For each asset in the portfolio, a value of the Lagrange multiplier and its corresponding asset allocation are selected that improve the function's value over other possible Lagrange multiplier values and corresponding asset allocations.

In certain embodiments, the portfolio constraint can comprise a limitation that costs of executing recommended trades do not exceed benefits received from executing recommended trades. In certain embodiments, the portfolio constraint can comprise a limitation on a quantity of at least one asset in the portfolio. In certain embodiments, the net expected returns can comprise trading costs. In certain embodiments, the net expected returns can comprise at least one quantitative measure of a financial or thematic investment strategy.

In certain embodiments, the method can further comprise receiving a first allocation of assets selected from the plurality of assets that are available to purchase or sell; and with the first allocation of assets, decoupling one or more correlations between assets in the net expected returns. In certain embodiments, the first allocation of assets can be the allocation of assets determined in a prior iteration. In certain embodiments, the method can comprise decoupling risk correlations between assets in the net expected returns.

In certain embodiments, the method further can comprise determining a set of one or more Lagrange multipliers that cause the allocation of the asset that corresponds to the Lagrange multiplier to change from one value to another value; and from the set of one or more Lagrange multipliers, selecting the Lagrange multiplier and the corresponding asset allocation that give the best improvement in the function's value.

In certain embodiments, the method can further comprise recalculating the allocation of at least one asset in the portfolio to change the allocation from a real number comprising a fractional part to an integer value.

In another embodiment, a computer system is provided comprising a database configured to store input data comprising assets available to buy or sell and configured to store an output allocation of the assets. The, computer system further comprises at least one processor configured to receive the input data and calculate net expected returns of the assets and a portfolio constraint comprising at least one limitation on the extent that assets can be allocated. The computer system further comprises a portfolio management module configured to determine the output allocation by independently processing each asset in the plurality of assets and selecting a value of a Lagrange multiplier and a corresponding asset allocation that improves net expected returns and enforces the constraint.

In certain embodiments, the portfolio constraint can comprise a limitation that costs of executing trades do not exceed benefits of executing trades. In certain embodiments, the portfolio constraint can comprise a limitation on a quantity of at least one asset allocation. In certain embodiments, the input data and the net expected returns can comprise trading costs. In certain embodiments, the input data and the net expected returns can comprise at least one quantitative measure of a financial or thematic investment strategy.

In certain embodiments, the at least one processor is further configured to receive the output allocation of the assets and with the output allocation, decouple one or more correlations between assets in the net expected returns. In certain embodiments, the at least one processor is configured to decouple risk correlations between assets in the net expected returns.

In certain embodiments, the portfolio management module can be further configured to determine a set of one or more Lagrange multipliers that cause the allocation of the asset that corresponds to the Lagrange multiplier to change from one value to another value. in certain embodiments, the portfolio management module can be further configured to recalculate at least a portion of the allocation of assets to change real numbers comprising a fractional part to integer values.

For purposes of summarizing the embodiments and the advantages achieved over the prior art, certain items and advantages are described herein. Of course, it is to be understood that not necessarily all such items or advantages may be achieved in accordance with any particular embodiment. Thus, for example, those skilled in the art will recognize that the inventions may be embodied or carried out in a manner that achieves or optimizes one advantage or group of advantages as taught or suggested herein without necessarily achieving other advantages as may be taught or suggested herein. The flow charts described herein do not imply a fixed order to the steps, and embodiments of the invention may be practiced in any order that is practicable.

Aspects of this disclosure are also described in Provisional Patent Application No. 60/908,848, filed on Mar. 29, 2007, which is hereby incorporated by reference in its entirety.

### BRIEF DESCRIPTION OF THE DRAWINGS

A general architecture that implements the various features of the disclosed systems and methods will now be described with reference to the drawings. The drawings and the associated descriptions are provided to illustrate embodiments and not to limit the scope of the disclosure. Throughout the drawings, reference numbers are re-used to indicate correspondence between referenced elements. In addition, the first digit of each reference number indicates the figure in which the element first appears.

FIG. 1 is a block diagram showing an overview of an investment management problem.

FIG. 2 is a block diagram illustrating an investment management method according to one embodiment.

FIG. 3 illustrates an investment services platform whereby an investor can interact with investment service providers.

FIG. 4 illustrates a contract management table to assist in managing contracts with investment service providers.

FIG. 5 illustrates an asset attribute table for storing attribute values received from an investment service provider.

FIG. 6 illustrates a service provider forecast table for storing asset risk and return data from investment service providers.

FIG. 7 illustrates an integrated asset forecast table for storing integrated risk and return data compiled from investment service providers.

FIG. 8 illustrates an example diagonal asset-asset correlation matrix.

FIG. 9 illustrates a first example asset hierarchy.

FIG. 10 illustrates a second example asset hierarchy.

FIG. 11 illustrates an investment rules interface for defining rules at various hierarchy levels.

FIG. 12 is a block diagram showing an overview of an investment management problem.

FIG. 13 is a block diagram illustrating an investment management method according to one embodiment.

FIG. 14 is a block diagram illustrating a method of decoupling variables.

FIG. 15 is a more detailed block diagram illustrating a method of decoupling variables.

FIG. 16 is a plot of n, versus Lagrange multiplier γᵢ for an example Lagrangian function.

FIG. 17 is a block diagram illustrating a method of providing a quantized solution.

FIG. 18 is a more detailed block diagram illustrating a method of providing a quantized solution.

FIG. 19 is a more detailed block diagram illustrating a method of providing a quantized solution.

FIG. 20 shows an investment management system according to one embodiment.

### DETAILED DESCRIPTION

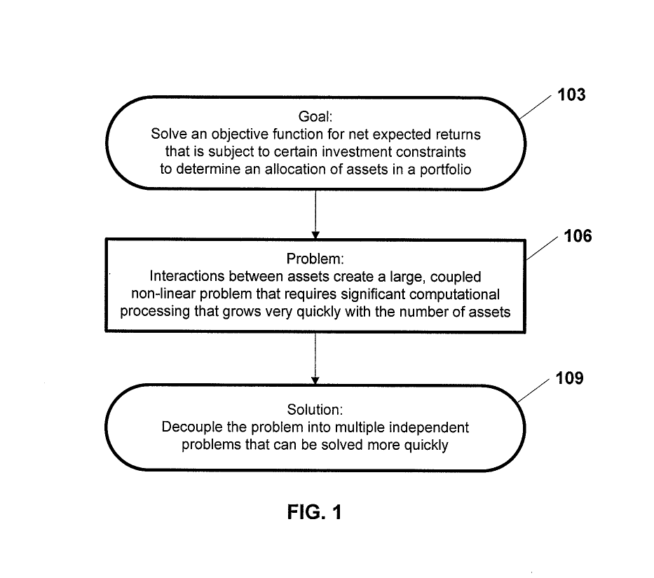

For a more detailed understanding of the disclosure, reference is first made to FIG. 1, which illustrates an overview of the investment management problem. As explained in block 103, in certain embodiments, an investor managing a portfolio subject to certain investment constraints seeks to determine an allocation of assets that improves the net expected return of the portfolio.

However, as explained in block 106 the number of calculations to solve the MPT objective function increases non-linearly as a function of the number of available assets because of interrelationships between assets in the objective function and in the constraints.

Therefore, as described in block 109, systems and methods are provided to separate aspects of the objective function and constraints, permitting the objective function and/or constraints to be processed for each asset independently. The systems and methods can allow each asset to be optimized independently. In certain embodiments, an iterative approach is used that allows each asset to be optimized independently at each iteration, providing scalable investment management systems and methods. The systems and methods disclosed herein reduce the amount of calculations that are traditionally required to solve an MPT objective function.

In accordance with the disclosed system and methods, processing time required to solve an objective function subject to certain constraints can be reduced from days to seconds. Consequently, greater numbers of assets that can be evaluated. Furthermore, implementing the systems and methods can lower hardware cost requirements from about $1,000,000 to about $1,000 and/or provide more accurate solutions.

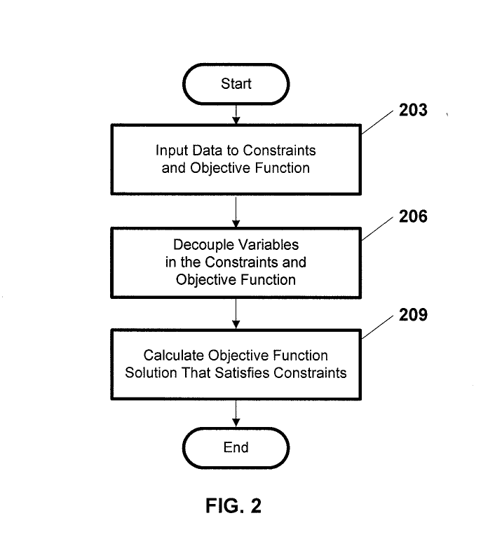

FIG. 2 depicts an overview of an example embodiment. The method shown in FIG. 2 comprises inputting data to the constraints and the objective function 203, decoupling asset-asset interactions in the constraints and the objective function 206, and calculating an objective function solution that satisfies the constraints 209.

As explained above, in certain embodiments, the investor inputs data to the constraints and the objective function 203. The input data can include the example input data shown in TABLE 1 below. More or fewer input parameter data can be used in various embodiments. For example, an embodiment that does not comprise a line search does not include I^{LS} as input data. An embodiment that does not comprise an iterative approach for quantizing the solution may not include I^{Q} as input data. Certain embodiments can comprise additional input data including, but not limited to, personal information, investing rules, existing portfolio data, tax data, forecast estimates, asset-specific trade data such as asset name, bid/ask pricing, asset ticker, parent exchange, or additional asset-to-asset correlation information.

TABLE 1
Example Input Data

| Parameter | Description |
|---|---|
| rᵢ | Forecast return for asset i |
| pᵢ | Current price/share for asset i |
| tᵢ | Trading cost/share for asset i |
| nᵢ^{o} | Number of shares for asset i in current portfolio |
| λₛ | Strategic weight for investment strategy s |
| x_{s, i} | Asset i's contribution to investment strategy s |
| σ_{i, j} | Asset-asset risk correlation |
| nᵢ^{min} | Investor Rule: Minimum number of shares of asset i |
| | in a portfolio |
| nᵢ^{max} | Investor Rule: Maximum number of shares of asset i |
| | in a portfolio |
| I^{Q} | Iterations for Quantized Solution |
| I^{LS} | Iterations for Line Search |

In certain embodiments, the input data comprises one or more asset attributes. An attribute is a characteristic associated with a particular asset. Examples include, but are not limited to, financial attributes such as dividends, P/E ratio, yield, cash flow, etc. Asset attributes can also be thematic attributes, such as “environmental friendliness,” “renewable energy,” “military applications,” “nuclear power applications,” etc.

Asset attributes can be defined in various computer programming data types including string, Boolean, integer, floating point, etc., as needed. For example, an “international” or “dividend paying” asset attribute can be defined as a Boolean data type, that is, true or false. An “environmental friendliness” asset attribute can be an Integer data type. A particular asset can have more than one asset attribute. For example, an asset can have the attributes of international and dividend paying, and the asset can also have attributes of P/E ratio, cash flow, and dividends.

A variety of techniques for inputting data can be used. In certain embodiments, input data is received into the system using a keyboard, a media reader such as a CD or DVD drive, and/or a TCP/IP or other network interface. In certain embodiments, input data is stored in one or more databases.

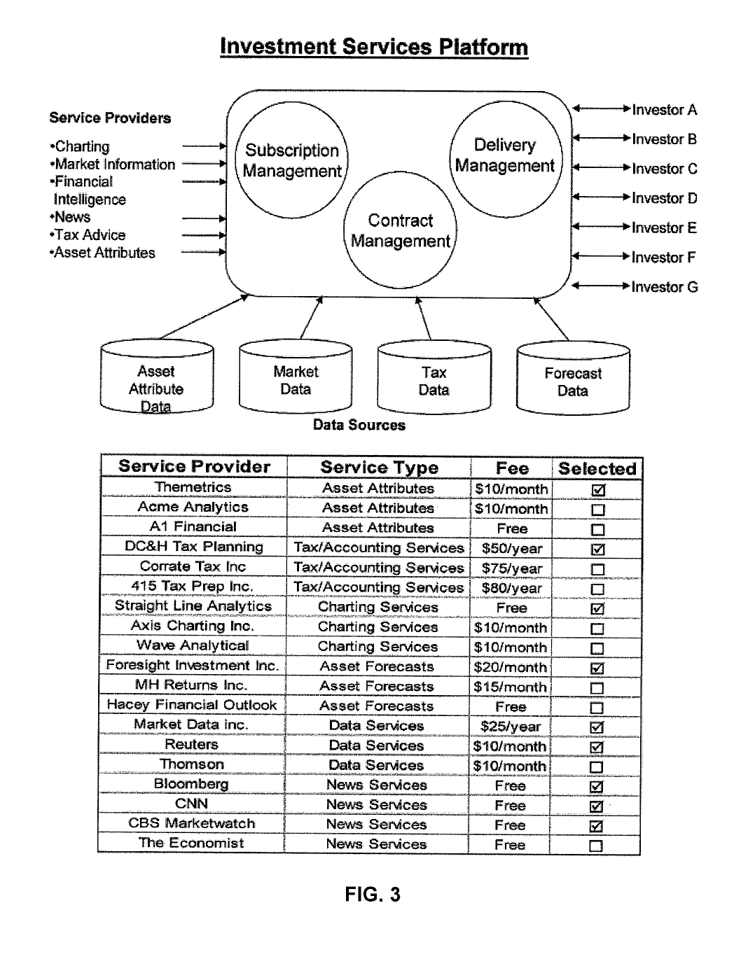

An input technique can include an investment services platform whereby an investor can interact, as shown in FIG. 3, with various investment service providers. The investment services platform is a portal by which input data can be received from information service providers. Examples of information service providers are fee-based subscription services and free information resources. Information service providers can include tax services, asset risk and return forecasting services, asset attribute information services, brokerage services, financial intelligence services, data vendors, charting services, and/or news services.

TABLE 2 provides an example of the type of information an information service provider can furnish. In that example, an investment services asset provider supplies input data on various assets' attribute of Environmental Friendliness.

TABLE 2
Example Input Data Provided by Information Service Provider

| Asset | Attribute | Attribute Value | Scale/Units |
|---|---|---|---|
| Exxon Mobil | Environmental | 17 | 1-100, 100 best |
| | Friendliness | | |
| Halliburton | Environmental | 22 | 1-100, 100 best |
| | Friendliness | | |
| Evergreen Solar | Environmental | 91 | 1-100, 100 best |
| | Friendliness | | |
| Sunpower Corp. | Environmental | 93 | 1-100, 100 best |
| | Friendliness | | |

The investment services platform can serve as an interactive medium through which investors and service providers interact. For example, the investment services platform can be a web-based system that includes a graphical user interface displayed on an investor's computer monitor. The graphical user interface can present the user with options for reviewing, selecting, and subscribe to various services. The user can access the information resources from the selected service providers, which can be integrated as input data for the systems and methods described herein. For example, select asset risk and return forecasts from one or more information service providers can be incorporated into the investment services platform.

The investor can interact with the investment services platform to subscribe to services. For example, the investor services platform can present an investor with an electronic subscription contract on a graphical user interface displayed on the investor's computer monitor. The investor can use a keyboard or other input device to enter data into the electronic subscription contract. At the user's command, the investment services platform transmits the electronic subscription contract to the relevant service provider(s) via an Internet connection. The service provider(s) can provide input data within the scope of the electronic subscription to the investment services platform, either automatically or at an investor's command.

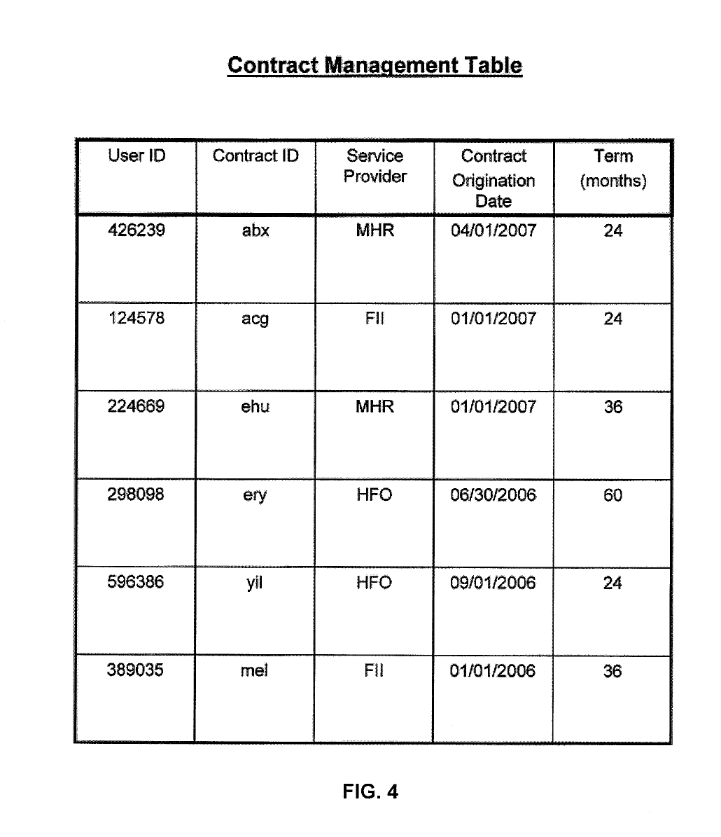

In order to manage subscription contracts, certain embodiments can provide for the management of contract information. An example contract management table is shown in FIG. 4.

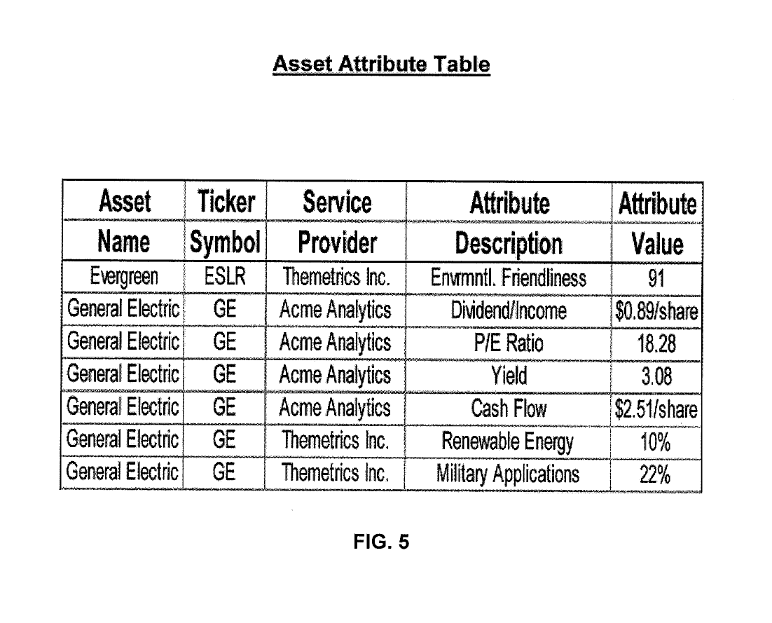

Input data from information service providers can subsequently populate, for example, an Asset Attribute Table as shown in FIG. 5. In certain embodiments, other attribute data structures can be used.

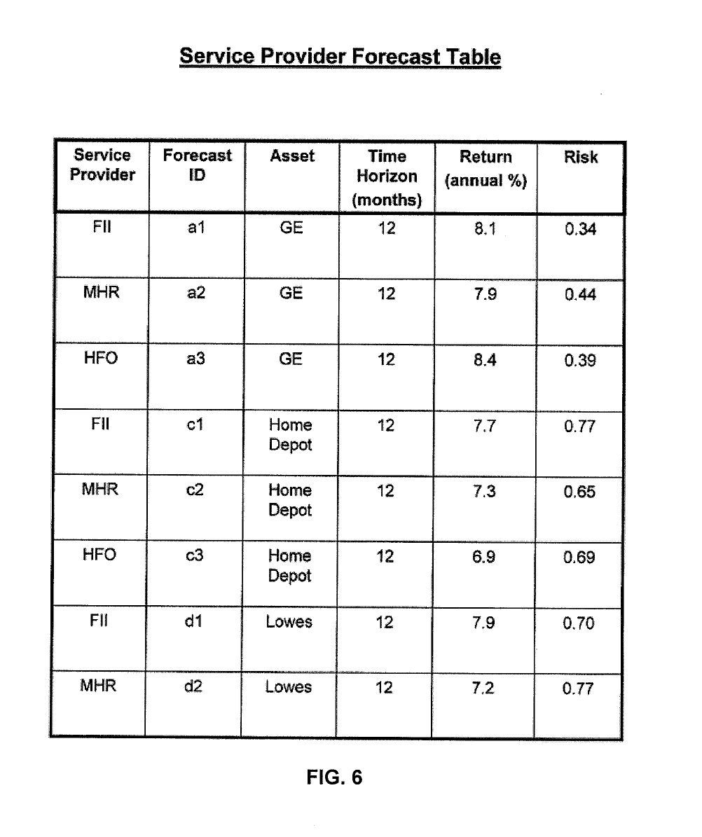

As described above, users can subscribe to forecasting services via the investment services platform. The subscribed forecasting services transmit input data including, for example, asset risk and return data via an Internet connection to the investment services platform. The asset risk and return input data can be stored, for example, in the form of a service provider forecast table as shown in FIG. 6.

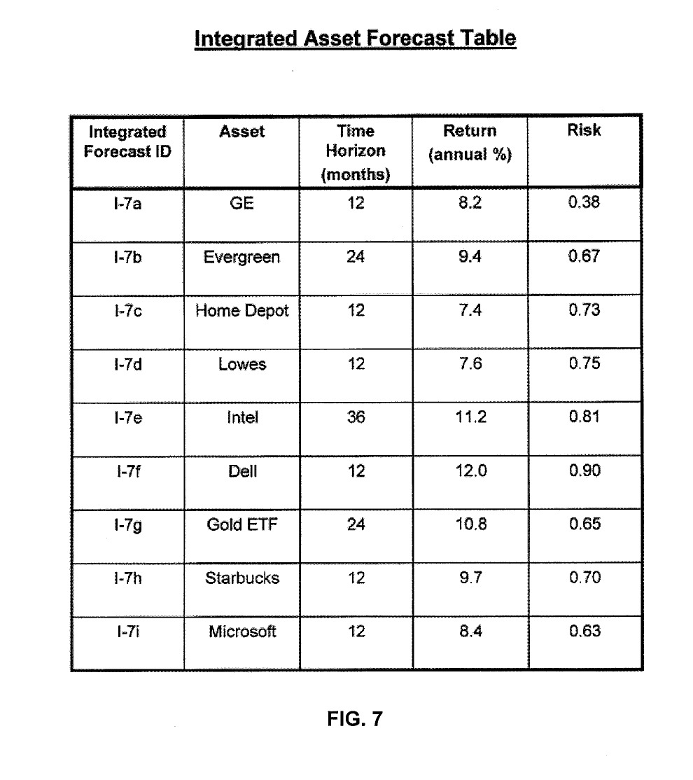

In certain embodiments, input data from multiple information service providers can be combined. For example, asset risk and return input data from multiple forecasting services can be integrated into one datum point for a specific asset. One technique for combining input data from multiple information service providers is calculating a mathematical average. In certain embodiments, a Bayesian methodology is used to combine input data from multiple information service providers (e.g., integrating multiple asset risk and return forecasts into one numerical forecast). Integrated forecasts can populate an integrated asset forecast table as shown in FIG. 7. Other combined input data can be stored in other data structures in certain embodiments.

Turning again to FIG. 2, as previously described, the example method comprises inputting data to the constraints and the objective function 203. In certain embodiments, the objective function represents the net expected returns. An example objective function comprises three components: expected returns, trading costs, and investment strategies. These three components are expressed below in EQ. 1.

$$F [ \{ n \} ] = {\sum }_{i} {r}_{i} {p}_{i} {n}_{i} - {\sum }_{i} {t}_{i} \vert {n}_{i} - {n}_{i}^{o} \vert - {\sum }_{s} ( \frac{{λ}_{s}}{1 - {λ}_{s}} ) {W}_{s} [ \{ n \} ] \qquad ( 1 )$$

The first summation term in EQ. 1 accounts for expected returns, the second summation term accounts for trading costs, and the third summation term accounts for investment strategies.

In the first summation term in EQ. 1, rᵢ represents the forecast return per share of asset i at some time in the future; pᵢ represents the price per share of asset i; and nᵢ represents the number of shares of asset i in the new portfolio. In the second summation term, tᵢ represents the trading cost per share of asset i, and nᵢ^{o} represents the number of shares in the current portfolio. In the third summation term, λₛ represents the strategic weight for a certain investment strategy function Wₛ. Certain terms are described in more detail below.

Certain embodiments can eliminate terms from, add terms to, or vary terms in the objective function shown in EQ. 1. For instance, an objective function can be constructed to account for risk and return, without accounting for investment strategies and trading costs. As another example, certain embodiments can add a term accounting for taxes incurred by certain trades.

As still another example of modifications to the example objective function, certain embodiments can vary the term representing trading costs. In the example embodiment of EQ. 1, there is a trading cost per share of asset i, represented as tᵢ. Thus, in EQ. 1, the total trading costs are represented as the trading cost per share of asset i, multiplied by the change in total number of shares of asset i between a new set of assets {n} and an old set of assets {n^{o}} in a portfolio, and summed over all assets i. However, certain brokerage entities use other trading cost models. For instance, a brokerage entity can charge a flat fee for all trades, regardless of the number of trades made and/or the number of different assets traded. Other brokerage entities can use a tiered trading cost model that incorporates a certain cost per share if 100 shares or fewer are traded, a lower cost per share if between 101 and 500 shares or fewer are traded, and a still lower cost per share if between 501 and 1,000 shares are traded. Other variations are possible. Consequently, a different trading cost term can be used to accommodate the specific trading cost model used by a brokerage entity.

Turning again to EQ. 1, shown above, in certain embodiments, an investor can have one or more investor strategies. Investor strategies are accounted for by the third summation term of EQ. 1.

Strategies can be expressed by the use of investor strategy functions Wₛ, which comprise quantitative measures of a strategy. Example investor strategy functions are shown in TABLE 3 below.

TABLE 3
Example Investor Strategies

| s | Strategy | Wₛ[{n}] | Comment |
|---|---|---|---|
| 0 | Risk | ${\sum }_{i , j} ( {p}_{i} {σ}_{i , j} {p}_{j} ) {n}_{i} {n}_{j}$ | Controls historical correlated risk |
| 1 | Income | Σᵢ x_{1,i} nᵢ | Controls income. x_{1,i} represents |
| | | | the income per share of asset i |
| 2 | Environmental | Σᵢ x_{2,i} nᵢ | Controls environmental |
| | Friendliness | | friendliness. x_{2,i} is a measure of |
| | | | environmental friendliness per |
| | | | share for asset i |
| 3 | Commodities | Σᵢ x_{3,i} nᵢ | Controls allocation to |
| | | | commodities. If the asset is a |
| | | | commodity x_{3,i} = pᵢ, otherwise |
| | | | x_{3,i} = 0. |

In strategy s=0, σ_{i,j} is a strategic measure representing the risk correlation of asset i to asset j. In general, for strategies s=1 through 3, x_{s,i} is a strategic measure representing the contribution of asset i to the investment strategy s. In certain embodiments, x_{s,i} can be investor rules, which are discussed in more detail below.

Investor strategies can be financial or thematic. Financial strategies can include portfolio risk, income, and liquidity. Thematic strategies can be established to allow an investor to develop and strategically manage allocations based on “ES&G” (that is Environmental, Social, and Governance) investing themes, such as renewable energy, environmental friendliness, and attractiveness of corporate governance, as well as other themes.

The investor strategy functions, Wₛ, provide a quantitative measurement of investor strategies. Accordingly, the terms of Wₛ should be objective. For example, the term x_{1,i} in TABLE 3 above, which represents a strategic measure for the strategy “Income,” could be $0.25/share for a specific asset i. The term x_{2,i}, which is a strategic measure for the strategy “Environmental Friendliness,” could be 91 (out of a scale of 1-100) for a specific asset i. The values for the strategic measures are drawn in this example from the asset attribute table shown in FIG. 5 and the integrated asset forecast table shown in FIG. 7.

The input data collected from various investment services providers are not necessarily numeric. Alphabetical ratings (e.g., bond ratings of “AAA” to “D”) are an example of non-numeric input data. Non-numeric input data can be formatted or normalized for use as strategic measures (x_{s,i}) within the objective function as numeric terms. The conversion process from input data to numeric strategic measure can vary depending on the implementation.

As shown in TABLE 3, the term x_{s,i} can be used to control which assets should be included in a portfolio. For example, if a user desires to exclude assets with an “Environmental Friendliness” attribute value smaller than 50, the investor can create or set an investor rule such that assets with this attribute value ≧50 will be considered for inclusion. That is to say, if Environmental Friendliness ≧50, then x_{s,i}=pᵢ, else x_{s,i}=0. If a user desires to select U.S. stocks, then assets flagged with the attribute value of International equal to True will not be considered for inclusion in asset set. That is to say, if International=True, then x_{s,i}=0, else x_{s,i}=pᵢ.

Investor strategies other than the ones shown in TABLE 3 are possible. For example, in certain embodiments, an investor can account for systemic risk and/or forecast uncertainty risk, financial strategies. In certain embodiments, an investor can define a strategy that controls allocation to dividend-paying stocks, another financial strategy. In certain embodiments, an investor can define strategies to control allocation to energy stocks or renewable energy assets, thematic strategies. An investor can, in certain embodiments, account for corporate governance (thematic) or liquidity (financial).

In certain embodiments, the number of strategies included in the objective function is configurable by the investor. An investor can add and/or delete any number of strategies without requiring the application to be reprogrammed.

Investment strategies can be determined by the investor's interaction with the investment services platform and/or the investment rules interface described above. For example, if the investor selects information from an information service provider on corporate rankings for environmental friendliness, then “Environmental Friendliness” can be used as a strategy. In certain embodiments, there is a default set of strategies for the investor to select. In certain embodiments, the investor can define strategies within the investment rules interface.

As shown above in EQ. 1, each investment strategy function Wₛ can include a corresponding strategic weight λₛ that the investor controls. In certain embodiments, the strategic weight value can range between 0 and 1. If the investor wants to remove an investment strategy function from the net expected return equation, then the investor sets λₛ=0. As λ_{S}→1, the investment strategy function becomes more important in the net expected return calculation. The third summation is calculated over all strategies (s). As explained above, certain embodiments can vary terms in, eliminate terms from, or add terms to the expression of the net expected returns. Therefore, in certain embodiments, the investor is not able to control the strategic weight λₛ.

Embodiments that include one or more strategic weights λₛ can advantageously help investors to manage weighting portfolios along themes and/or help balance the tradeoff between returns and themes.

In certain embodiments, multiple sets of assets for a portfolio can be created. For instance, multiple sets of assets can be created by accounting for a plurality of investor strategy functions, wherein each investor strategy function is associated with a corresponding strategic weight. An investor can evaluate the changes in net expected return as strategic weights are varied.

For example, instead of defining a single acceptable strategic weight λₛ for an investor strategy function Wₛ, an investor can define a range of suitable strategic weights for each investor strategy function Wₛ. Multiple sets of assets can be created to improve the net expected returns (F) over a current set of assets in a portfolio at various λₛ values within these ranges, for example, by incrementing λₛ at regular amounts.

A process is described herein by which strategic weights (λₛ) are determined and used in the example embodiment above. As shown below in TABLE 4, the λₛ values can be numerical ranges with preset steps that populate a strategic weight sampling table. The example embodiment of TABLE 4 includes three strategies. However, as discussed above, the number of strategies is determined by the investor.

TABLE 4
Strategic Weight Sampling Table

| Strategy “s” | λₛ^{MIN} | λₛ^{MAX} | λₛ^{STEP} |
|---|---|---|---|
| 1 | 0 | 1 | 0.2 |
| 2 | 1 | 3 | 1.0 |
| 3 | 0 | 0.2 | 0.1 |

These strategic weight values populate a strategic weight table, which contains the combinations of the weights for the strategies, as shown below in TABLE 5. In this example, Portfolio 1 corresponds to a scenario in which λₛ=λₛ^{MIN} for each strategy s. Portfolio 2 increments λ₃ by λₛ^{STEP} (0.1), while leaving λ₁ and λ₂ unchanged. For the example λₛ^{MIN}, λₛ^{MAX}, and λₛ^{STEP} values provided in TABLE 4, there are 72 possible combinations.

TABLE 5
Strategic Weight Table

| Asset Set | λₛ for s = 1 | λₛ for s = 2 | λₛ for s = 3 |
|---|---|---|---|
| 1 | 0 | 1 | 0 |
| 2 | 0 | 1 | 0.1 |
| 3 | 0 | 1 | 0.2 |
| 4 | 0 | 2 | 0 |
| 5 | 0 | 2 | 0.1 |
| 6 | 0 | 2 | 0.2 |
| 7 | 0 | 3 | 0 |
| 8 | 0 | 3 | 0.1 |
| 9 | 0 | 3 | 0.2 |
| 10 | 0.2 | 1 | 0 |
| 11 | 0.2 | 1 | 0.1 |
| 12 | 0.2 | 1 | 0.2 |
| . . . | . . . | . . . | . . . |
| 72 | 1 | 3 | 0.2 |

As shown in the example in TABLE 5, there are 72 combinations of the strategic weights given for the example of TABLE 4. Each specific combination is designated as an “Asset Set,” as indicated in the first column of TABLE 5. The strategic weights for each Asset Set are then input into the objective function (F), described above with respect to EQ. 1, which through the systems and methods described herein yields a unique solution for those input strategic measures and weights. A tabular representation of the output from the objective function can be shown as follows in TABLE 6. The values in TABLE 6 below are example solutions, and the actual values used for or corresponding to any given embodiment or implementation will vary with the particular situation.

TABLE 6
Net Expected Return for Each Asset Set

| | | | | W₃ |
|---|---|---|---|---|
| | Net Expected | W₁ | W₂ | Environmental |
| Asset Set | Return % (F) | Risk | Portfolio Income | Friendliness |
| 1 | 12.3 | 0.053 | $13,850 | 68 |
| 2 | 9.3 | 0.066 | $12,100 | 45 |
| 3 | 10.3 | 0.037 | $8,900 | 87 |
| 4 | 11.75 | 0.087 | $21,800 | 59 |
| . . . | . . . | . . . | . . . | . . . |
| 72 | 9.5 | 0.063 | $19,050 | 28 |

As shown in TABLE 6, each asset set has a return associated with each combination of strategic measures. These different return scenarios can be displayed graphically to the investor, for example, in a window of a computer monitor. The graphical display can show how portfolio return varies with changes in the strategic weights.

A benefit of the mechanism described above is to provide the investor with the ability to alter the weightings assigned to various strategies and to interactively see (e.g., in the user interface window) how this affects the net expected return of the assets selected for a portfolio.

As described above with respect to EQ. 1, TABLE 2, and TABLE 3, input data can comprise σ_{i,j}, that is, a strategic measure representing asset-asset risk correlations. As shown in TABLE 3, this input data can be used in an investor strategy that controls historical correlated risk. In certain embodiments, σ_{i,j} can be calculated from historical asset price information. For example, historical asset price information can be combined with estimated confidence and correlation values using a Bayesian methodology to develop an asset-asset correlation matrix. In certain embodiments, this methodology can comprise determining the specific asset value correlative behavior between individual assets.

In certain embodiments, the correlation process can use a method as set forth below in which a historical asset price is accounted for by adjusting a predicted value using error terms attributable to various sources. EQ. 2 shows a set of equations for calculating the price of an asset at a certain time.

$${P}_{1 , t} = {\hat{P}}_{1 , t} ( 1 + {σ}_{1 , 1} {ɛ}_{1 , t} ) \\ {P}_{2 , t} = {\hat{P}}_{2 , t} ( 1 + {σ}_{2 , 1} {ɛ}_{1 , t} ) ( 1 + {σ}_{2 , 2} {ɛ}_{2 , t} ) \\ {P}_{3 , t} = {\hat{P}}_{3 , t} ( 1 + {σ}_{3 , 1} {ɛ}_{1 , t} ) ( 1 + {σ}_{3 , 2} {ɛ}_{2 , t} ) ( 1 + {σ}_{3 , 3} {ɛ}_{3 , t} ) \\ ⋮ \\ \begin{matrix}{P}_{N , t} = {\hat{P}}_{N , t} ( 1 + {σ}_{N , 1} {ɛ}_{1 , t} ) ( 1 + {σ}_{N , 2} {ɛ}_{2 , t} ) \\ ( 1 + {σ}_{N , 3} {ɛ}_{3 , t} ) … ( 1 + {σ}_{N , N} {ɛ}_{N , t} )\end{matrix} \qquad ( 2 )$$

where
P_{N,t}=the price of asset N at time t
\hat{P}_{N,t}=the model predicted price of asset N at time t
σ_{i,j}=the correlation of asset i's forecast error with asset j's forecast error
ε²_{N,t}=the historical volatility for the model for asset N at time t

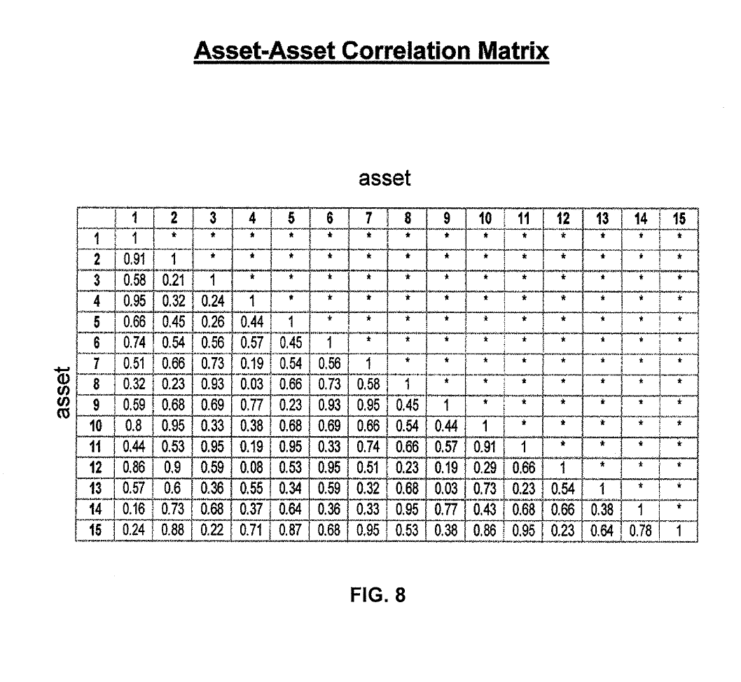

From the set of equations shown in EQ. 2, a diagonal matrix, as shown in FIG. 8, can be developed in which asset correlation factors are calculated. The asset correlation values (σ_{i,j} terms) from this matrix can be used as inputs to the objective function discussed above with respect to EQ. 1.

Other methods for determining asset correlation values can also be used in certain embodiments. For example, a correlation matrix can be constructed using covariance values amongst assets. As another example, asset correlation values can be determined using a single or multiple factor model.

Turning again to FIG. 2, the systems and method can comprise inputting data to constraints and an objective function 203. The objective function shown in EQ. 1 was discussed above. In certain embodiments, the objective function is subject to certain constraints, including for example, a portfolio rebalance constraint. The portfolio rebalance constraint can ensure that for the set of assets {n}, the net expected return for a set of assets exceeds the costs of transacting the trades during rebalancing. In certain embodiments, the portfolio rebalance constraint can be represented by EQ. 3. However, other portfolio rebalance constraints can be used.

$$G [ \{ n \} ] = {\sum }_{i} {p}_{i} {n}_{i} - ( {\sum }_{i} {p}_{i} {n}_{i}^{o} - {\sum }_{i} {t}_{i} \vert {n}_{i} - {n}_{i}^{o} \vert ) \leq 0 \qquad ( 3 )$$

In EQ. 3, the first summation represents the value of a new set of assets selected from available assets i. The second summation represents the current value of the portfolio. The third summation represents the trading costs incurred on rebalancing, that is, buying and selling shares of assets to move from the set of assets in the current portfolio to the new set of assets.

In certain embodiments, the constraints further comprise investor rules that ensure that an asset allocation is within the investor's tolerances. For example, for each asset i in available assets N, an investor can set a rule that nᵢ, the number of shares of asset i in a set of assets, is between a certain minimum nᵢ^{min} and maximum nᵢ^{max} number, as represented by EQ. 4.

nᵢ^{min}≦nᵢ≦nᵢ^{max}, nᵢ ∈ N (4)

As another example, in certain embodiments, investor rules can also include λₛ, the strategic weight for a certain investment strategy. Investor rules can act on specific assets and/or asset classes.

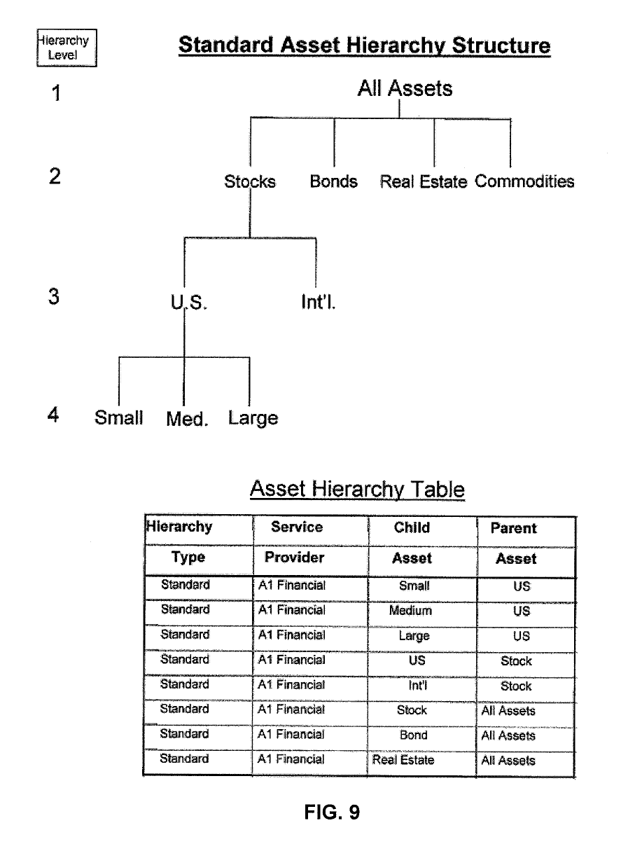

In certain embodiments, investor rules are selected via an investor rules interface. In certain embodiments, the investor rules interface comprises one or more hierarchies. FIG. 9 shows an example financial class hierarchy in the context of an investor rules interface. The example hierarchy shows, for example, that assets can be broken down from broader levels, such as stocks, bonds, real estate, and commodities, to progressively narrower levels. For example, stocks can be broken down into U.S. stocks and international stocks. U.S. stocks can be broken down into small, medium, and large cap stocks, and so forth.

A hierarchy can be stored as a database table. The table in FIG. 9 presents a tabular form of the hierarchy described above.

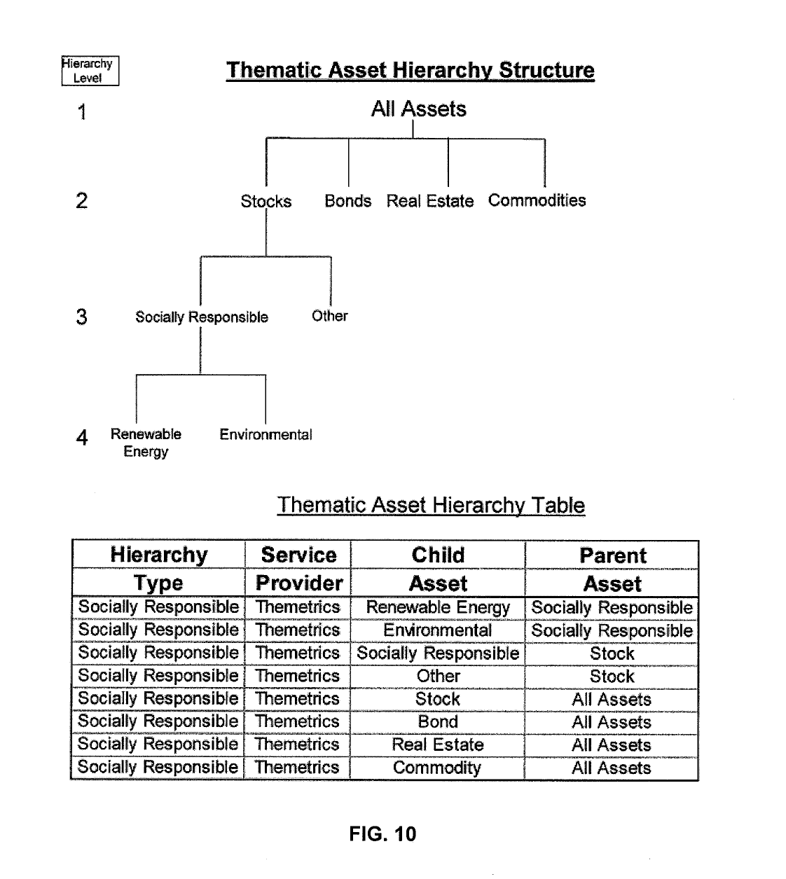

FIG. 10 illustrates thematic hierarchies, that is, hierarchies based on investment themes. As used herein, a “theme” is a quality or characteristic of an asset. The use of one or more themes in investment management as described herein permits the integration of various sources of investment advice and other information to aid in the selection of a desired investment portolio(s). The use of themes can allow an investor to incorporate both subjective and objective investment information.

Thematic asset hierarchies, either provided by default or customized by the user, can depend on the types of information sources available. As discussed above, input data including asset attributes can be retrieved from information service providers through the investment services platform. These attributes can be used to set up the thematic asset hierarchies. The investor can then set rules based on these thematic hierarchies as described above. In certain embodiments, an investor develops his or her own asset class hierarchical structure based on asset attribute information obtained by the investor from the investment services platform. The user bases his or her investing rules on the self-defined hierarchical structure.

In the example of FIG. 10, the broad financial class hierarchy “stocks” is broken down at a narrower thematic hierarchy level into themes including “Socially Responsible” and “Other.” The “Socially Responsible” thematic hierarchy level can subsequently be broken down into the narrower themes of “Renewable Energy” and “Environmentally Friendly.” As discussed above with respect to financial class hierarchies, an asset can be associated with more than one theme. For example, an asset can have the attributes of both “Renewable Energy” and “Corporate Governance,” and be associated with both Renewable Energy and Corporate Governance themes. As explained above, a hierarchy can be stored as a database table. FIG. 10 presents a tabular form of the hierarchy described above.

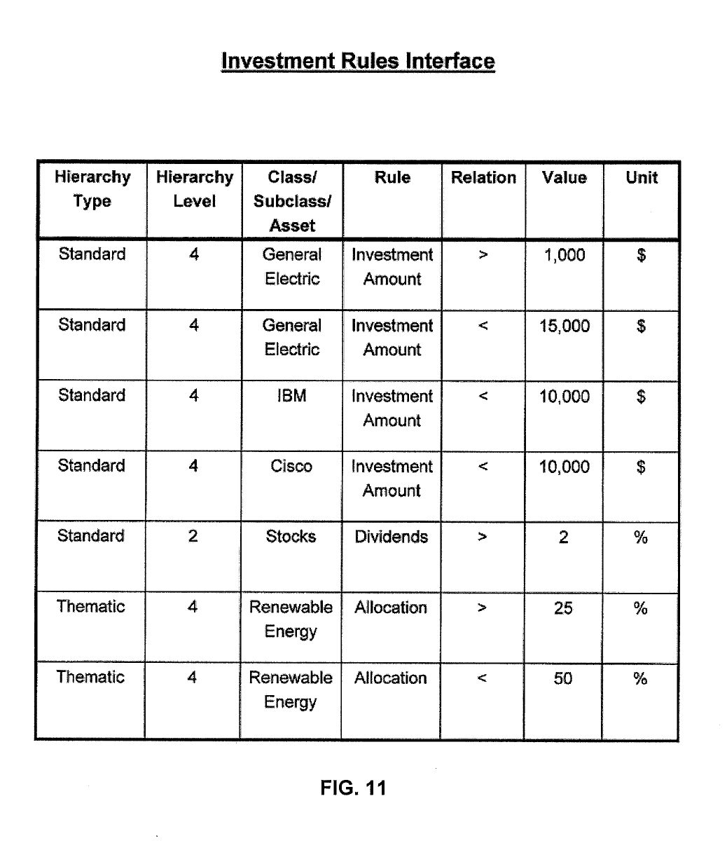

A representation of an example investor rules interface is shown in FIG. 11, in which exception-based rules for hierarchy levels are developed. As shown here, an investor rules interface can integrate both financial class and thematic hierarchies. An example is shown in which the investor defines a rule at the individual asset level, namely “hierarchy level 4,” in which no more than $10,000 of IBM stock is to be considered for inclusion in any second set of assets that improves net expected returns over a current set of assets in a portfolio. Investor rules can also be set for thematic hierarchy types. For example, as shown in FIG. 11, an investor can set a rule at hierarchy level 4 that greater than 25% but less than 50% the assets in a portfolio be allocated to “Renewable Energy” assets (that is, assets associated with the “Renewable Energy” theme).

In certain embodiments, the investor can set investment rules at each hierarchy level. For example, at a broad or parent hierarchy level, the investor can set a rule that U.S. stocks are to be included. At a narrower or child hierarchy level, the investor can set a rule that of those U.S. stocks, those stocks with a P/E ratio between 15 and 25 are to be included.

In certain embodiments, the investor can define his or her own custom hierarchies. For example, the investor can select a default hierarchy and make changes to the default hierarchy to create one or more custom hierarchies. In certain embodiments, an investor can add and/or delete hierarchies. Certain embodiments can comprise a single hierarchy. A single hierarchy can combine both standard and thematic elements.

Turning again to FIG. 2, which provides an overview of an example embodiment, it can helpful to express the objective function and constraints referred to in unit 203 in a more compact form by defining new variables. In certain embodiments, a computer processor performs these calculations and stores the results in the new variables. However, it is not necessary to define new variables and/or calculate their values in order to solve the objective function. In certain embodiments, a new variable ñᵢ can be defined as ñᵢ=nᵢ−nᵢ^{o}. The variables ñᵢ^{min} and ñᵢ^{max} can be defined as ñᵢ^{min}=nᵢ^{min}−nᵢ^{o} and ñᵢ^{max}=nᵢ^{max}−nᵢ^{o}, respectively. Further new variables, for example vᵢ and S_{i,j}, are shown in EQ. 4 and EQ. 5.

$$\begin{matrix}{v}_{i} = {r}_{i} {p}_{i} + {\sum }_{s = 1} ( \frac{{λ}_{s}}{1 - {λ}_{s}} ) {x}_{s , i} & ( 4 ) \\ {S}_{i , j} = ( \frac{{λ}_{0}}{1 - {λ}_{0}} ) {p}_{i} {σ}_{i , j} {p}_{j} & ( 5 )\end{matrix}$$

By substituting these new variables into EQ. 1, the objective function can be expressed as shown in EQ. 6.

$$F [ \{ \tilde{n} \} ] = {\sum }_{i} {v}_{i} {\tilde{n}}_{i} - {\sum }_{i , j} {\tilde{n}}_{i} {S}_{i , j} {\tilde{n}}_{j} - {\sum }_{i} {t}_{i} \vert {\tilde{n}}_{i} \vert \qquad ( 6 )$$

Furthermore, by substituting the new variables into the portfolio rebalance constraint shown in EQ. 3, the portfolio rebalance constraint can be expressed as shown in EQ. 7.

$$G [ \{ \tilde{n} \} ] = {\sum }_{i} {p}_{i} {\tilde{n}}_{i} + {\sum }_{i} {t}_{i} \vert {\tilde{n}}_{i} \vert \leq 0 \qquad ( 7 )$$

The investor rule of EQ. 4 can be expressed as shown in EQ. 8.

ñᵢ^{min}≦ñᵢ≦ñᵢ^{max}, ñᵢ ∈ N (8)

The portfolio rebalance constraint as expressed in EQ. 7 is piecewise linear with respect to ñᵢ, and accordingly the portfolio rebalance constraint of EQ. 7 can be expressed as shown in the form shown in EQ. 9 and EQ. 10.

$$G [ \{ \tilde{n} \} ] = {\sum }_{i} {g}_{i} [ {\tilde{n}}_{i} ] \qquad ( 9 )$$

where

gᵢ[ñᵢ]=pᵢñᵢ+tᵢ|ñᵢ| (10)

In certain embodiments, prior to calculating a set of assets that improves the net expected return of the portfolio while satisfying the portfolio rebalance constraint and other investor rules, it can be desirable to ascertain whether any set of assets satisfies the portfolio rebalance constraint and the investor rules.

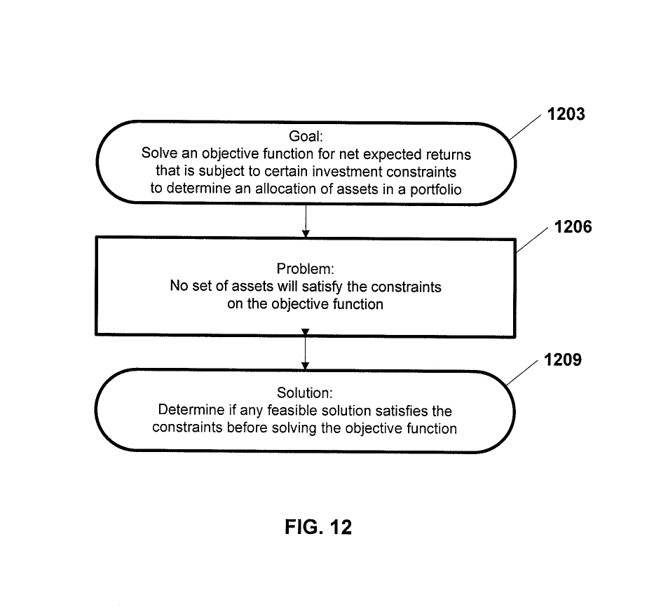

For a more detailed understanding of the problem and the disclosed solution, reference is now made to FIG. 12, which illustrates an overview of a pre-test method. As explained in block 1203, in certain embodiments, an investor managing a portfolio subject to certain investment constraints seeks to calculate a set of assets that improves the net expected return of the portfolio.

However, as explained in block 1206, in certain cases, no set of assets will satisfy the constraints on the objective function. Therefore, the calculation of block 1203 will not converge on a solution because no solution exists.

Therefore, as described in block 1209, systems and methods are provided to determine if any feasible solution satisfies the constraints before solving the objective function.

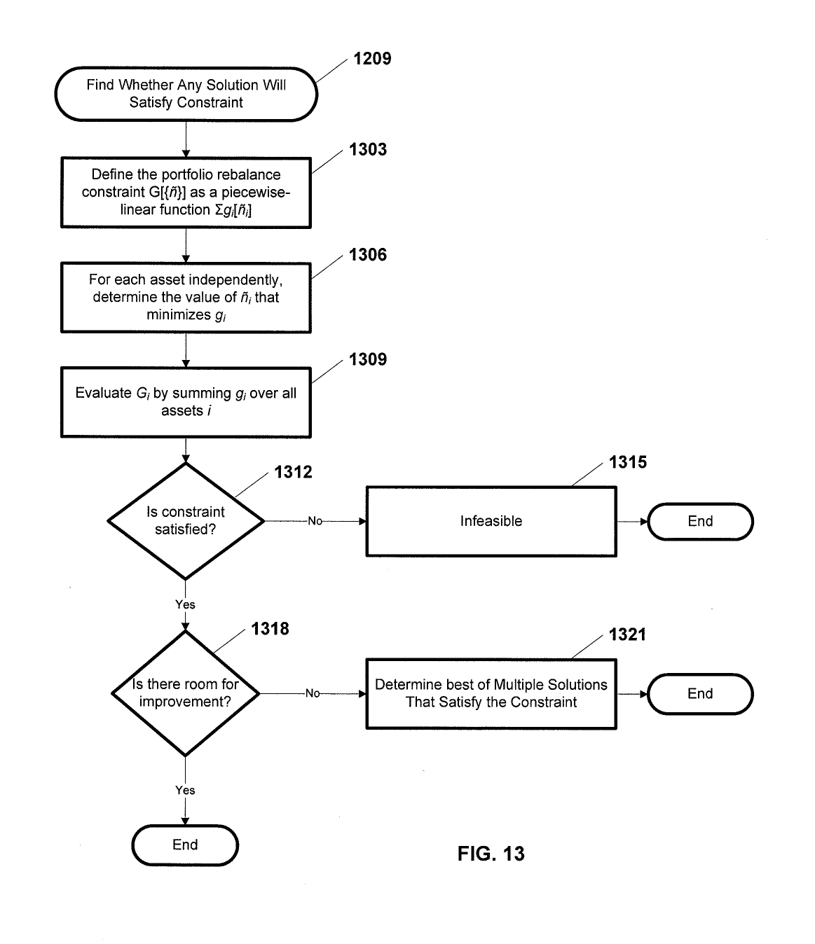

One technique for calculating a set of assets that satisfies the portfolio rebalance constraint is shown in FIG. 13. In one embodiment, this is achieved by finding the set of assets that minimizes the value of the portfolio rebalance constraint shown in EQ. 7 within the bounds set by investor rules, including the investor rule shown in EQ. 8. If the minimum value of the portfolio rebalance constraint G[{ñ}] is not less than or equal to zero, then no set of assets {ñ} satisfies the portfolio rebalance constraint.

As explained in block 1303, it is possible to define the portfolio rebalance constraint as a piecewise-linear function. The portfolio rebalance constraint G[{ñ}] is piecewise linear with respect to ñᵢ, as shown in EQ. 9 and EQ. 10. Consequently, as expressed in block 1306, G[{ñ}] can be minimized by minimizing each gᵢ[ñᵢ] independently, that is, by finding the value of ñᵢ that yields the smallest value of gᵢ[ñᵢ]. In view of the investor rule shown in EQ. 8, there are up to three potential values of ñᵢ^{k} that minimize gᵢ[ñᵢ]: ñᵢ^{max}, ñᵢ^{min}, and 0.

The following pseudocode demonstrates an example of how the investor rule shown in EQ. 8 can be enforced while finding the value of ñᵢ that minimizes gᵢ[ñᵢ] as described in block 1306. For each asset i, the solution ñᵢ^{k}* that yields the smallest value of gᵢ^{k} is evaluated. Using mathematical nomenclature, k*=k: min gᵢ^{k}.

IF (ñᵢ^{min} = ñᵢ^{max}) THEN Kᵢ = 1

ñᵢ¹ = ñᵢ^{min}
gᵢ¹ = pᵢñᵢ¹ + tᵢ|ñᵢ¹|
k* = k : min gᵢ^{k}

ELSE IF (ñᵢ^{max} ≦ 0 OR ñᵢ^{min} ≧ 0) THEN Kᵢ = 2

ñᵢ¹ = ñᵢ^{min}
ñᵢ² = ñᵢ^{max}
gᵢ¹ = pᵢñᵢ¹ + tᵢ|ñᵢ¹|
gᵢ² = pᵢñᵢ² + tᵢ|ñᵢ²|
k* = k : min gᵢ^{k}

ELSE Kᵢ = 3

ñᵢ¹ = ñᵢ^{min}
ñᵢ² = 0
ñᵢ³ = ñᵢ^{max}
gᵢ¹ = pᵢñᵢ¹ + tᵢ|ñᵢ¹|
gᵢ² = pᵢñᵢ² + tᵢ|ñᵢ²|
gᵢ³ = pᵢñᵢ³ + tᵢ|ñᵢ³|
k* = k : min gᵢ^{k}

END IF

In the psuedocode, the first if/then condition statement (denoted by Kᵢ=1) corresponds to the scenario in which the investor rule for asset i limits the allocation of asset i to a single value. The second if/then condition statement (denoted by Kᵢ=2) corresponds to the scenario either where the current allocation of the asset in the portfolio violates the investor rule of EQ. 8 or where the current allocation of the asset in the portfolio is already at the maximum or minimum possible value. The current allocation of the asset in the portfolio violates the investor rule of EQ. 8 either if the allocation is smaller than the minimum allowed allocation or larger than the maximum allowed allocation. If neither if/then condition statement as described for Kᵢ=1 or Kᵢ=2 is satisfied, then the third condition statement (denoted by Kᵢ=3) is evaluated.

Modifications to the example structure described by the above pseudocode can be made. For example, the second if/then condition statement can be separated into at least two if/then condition statements to evaluate the condition where ñᵢ^{max}≦0 and where ñᵢ^{max}≧0. As another example, if trading costs tᵢ are positive and ñᵢ^{min}≠ñᵢ^{max}, then the value of gᵢ[ñᵢ^{min}] will be smaller than gᵢ[ñᵢ^{max}]. Consequently, in certain embodiments, gᵢ[ñᵢ^{max}] is not evaluated. In certain embodiments, other investor rules can be incorporated and enforced.

In certain embodiments, if multiple solutions ñᵢ^{k}* yield the same value of gᵢ^{k}*, then the value of ñᵢ^{k}* is selected that also maximizes fᵢ^{k}=vᵢñᵢ^{k}−ñᵢ^{k}ΣⱼS_{i,j}ñⱼ^{k}*−tᵢ|ñᵢ^{k}|. In certain embodiments, if multiple solutions ñᵢ^{k}* yield the same value of gᵢ^{k}*, the solution ñᵢ^{k}* is assigned from the multiple solutions arbitrarily. In certain embodiments, a preference can be given to trading (e.g., ñᵢ^{k}*=ñᵢ^{min}) over not trading (ñᵢ^{k}*=0), or vice versa.

As described in block 1309, it is possible to evaluate the portfolio rebalance constraint by summing over assets. That is, by identifying the value of ñᵢ^{k}* that yields the smallest value of gᵢ^{k} for each asset i, the minimum value of the portfolio rebalance constraint can be calculated according to EQ. 11.

$${G}^{min} = {\sum }_{i} {g}_{i}^{{k}^{*}} \qquad ( 11 )$$

As described in block 1312, the portfolio rebalance constraint is evaluated to determine whether G^{min}≦0.

If G^{min}>0, there is no feasible solution, as shown in block 1315. That is to say, there is no set of assets that improves the net expected return of the portfolio and that also satisfies the portfolio rebalance constraint and/or any investor rules. Thus, in certain embodiments, no additional calculations are performed under the given conditions. In certain embodiments, the system provides an alert such as an audible and/or textual notification that there is no solution that satisfies the constraints.

If however G^{min}≦0, then as shown in block 1318 it is determined whether it is possible to further change the asset set {ñ} to improve the net expected returns.

If G^{min}=0, then it is not possible to change in the asset set {ñ} in a way that also changes the portfolio rebalance constraint. Because each asset is minimized independently, this is the smallest possible value for the portfolio rebalance constraint that also satisfies the investor rules. Further changes in nᵢ are likely to cause the portfolio rebalance constraint to be violated. However, it is possible to change nᵢ if multiple solutions ñᵢ^{k}* yield the same value of gᵢ^{k}*. As explained in block 1321, for each i that yields multiple equivalent solutions of gᵢ^{k}*, the value of ñᵢ^{k}* can be selected that also increases fᵢ^{k}=vᵢñᵢ^{k}−ñᵢ^{k}ΣⱼS_{i,j}ñⱼ^{k}*−tᵢ|ñᵢ^{k}|. In short, it is possible to improve the solution changing fᵢ but not by changing gᵢ. As described above, in certain embodiments, this step can previously be completed when solving for ñᵢ^{k}*. After determining the asset set {ñ}, the distribution nᵢ^{k}*=ñᵢ^{k}+nᵢ^{o} can be reported to the investor. As described in more detail below, further processing steps can also be conducted before returning an asset distribution to the investor.

If G^{min}<0, then it is possible to further change the asset set {ñ} to improve net expected returns by evaluating solutions that change the value of the portfolio rebalance constraint.

Reference is again made to FIG. 1, which illustrates an overview of the investment management problem. As explained in block 103, in certain embodiments, an investor managing a portfolio subject to certain investment constraints seeks to calculate a set of assets that improves the net expected return of the portfolio. However, as explained in block 106 the number of calculations to solve the objective function and its constraints increases non-linearly as a function of the number of available assets. Therefore, as described in block 109, systems and methods are provided to decouple variables in the constraints and/or objective function.

FIG. 2 depicts an overview of an example embodiment. The method shown in FIG. 2 comprises inputting data to the constraints and the objective function 203, decoupling variables in the constraints and the objective function 206, and calculating an objective function solution that satisfies the constraints 209.

Various techniques for decoupling variables in the constraints and the objective function are now described. In certain embodiments, asset-asset risk is decoupled by linearizing the quadratic risk term around an estimate of the solution. In certain embodiments, asset-asset interactions in the objective function and/or the portfolio rebalance constraint are decoupled by introducing a Lagrange multiplier, thereby allowing each asset to be processed independently. In certain embodiments, the estimate of the solution is iteratively refined using a line search algorithm until the method converges on a final solution.

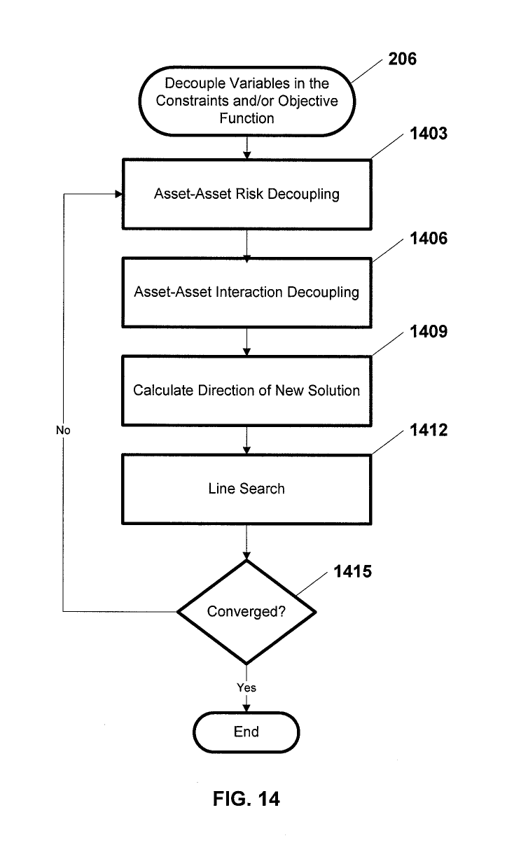

Referring now to FIG. 14, a method of decoupling asset-asset risk as shown in block 1403 is described. The risk term can be decoupled by linearizing it about the current estimate for the solution ñ*ⱼ′^{I} for the Ith iteration, for example, as shown in EQ. 12.

$${q}_{i} = {v}_{i} - {\sum }_{j} {S}_{i , j} {\tilde{n}}_{j}^{* , I} \qquad ( 12 )$$

In certain embodiments, the current estimate for the solution for the first iteration, ñ*ⱼ′^{I}, is equivalent to the asset distribution ñᵢ^{k}* calculated in the pre-test shown in FIG. 13 and described above that ascertains whether any set of assets satisfies the portfolio rebalance constraint and the investor rules. In certain embodiments, the current estimate for the solution for the Ith iteration, ñ*ⱼ′^{I} is the solution determined in a prior iteration.

Substituting the expression shown in EQ. 12 into the expression shown in EQ. 6 yields the expression shown below in EQ. 13. EQ. 13 represents an example expression for net expected returns in which the asset-asset risk term has been decoupled around a current estimate for the solution.

$$F [ \{ \tilde{n} \} ] = {\sum }_{i} {q}_{i} {\tilde{n}}_{i} - {\sum }_{i} {t}_{i} \vert {n}_{i} \vert \qquad ( 13 )$$

In certain embodiments, the problem is subject to the portfolio rebalance constraint shown above in EQ. 7 and reproduced below.

$$G [ \{ \tilde{n} \} ] = {\sum }_{i} {p}_{i} {\tilde{n}}_{i} + {\sum }_{i} {t}_{i} \vert {\tilde{n}}_{i} \vert \leq 0 \qquad ( 7 )$$

In certain embodiments, the problem is further subject to investor rules, including the investor rule shown in EQ. 8 and reproduced below.

ñᵢ^{min}≦ñᵢ≦ñᵢ^{max}, nᵢ ∈ N (8)

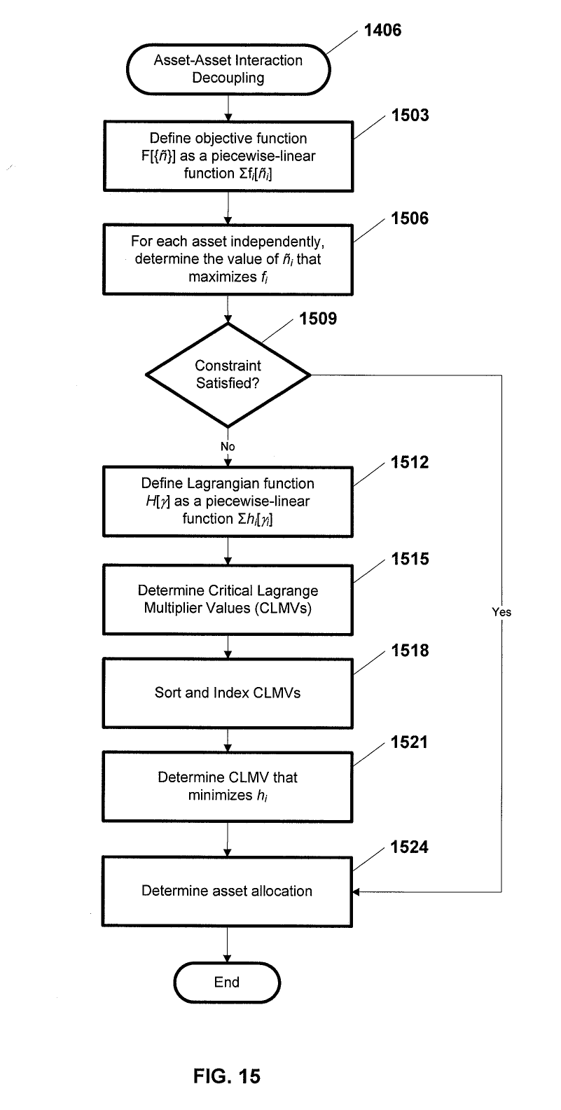

An example method of asset-asset interaction decoupling is now described. As shown in FIG. 15, in certain embodiments, asset-asset interactions in the objective function and/or the portfolio rebalance constraint are decoupled by introducing a Lagrange multiplier, thereby allowing each asset to be optimized independently. In certain embodiments, critical values of the Lagrange multiplier are determined where each asset will jump from one solution to a new solution. The value of the Lagrange multiplier that satisfies the portfolio rebalancing constraint while maximizing the objective function is determined.

In certain embodiments, alternative techniques for calculating a set of assets that improves the net expected return of the portfolio while satisfying the portfolio rebalance constraint and other investor rules that do not use Lagrange multipliers can be implemented.

In certain embodiments, one or more alternative techniques can be used in conjunction with Lagrange multiplier methods. For example, the following process can be performed before applying Lagrange multiplier methods to ascertain whether a set of assets that maximizes the net expected returns for each asset independently, subject to investor rules, also satisfies the portfolio rebalance constraint.

As explained in block 1503, it is possible to define the objective function as a piecewise-linear function. The objective function F[{ñ}] is piecewise linear with respect to ñᵢ, as shown in EQ. 14 and EQ. 15.

$$F [ \{ \tilde{n} \} ] = {\sum }_{i} {f}_{i} [ {\tilde{n}}_{i} ] \qquad ( 14 )$$

where

fᵢ[ñᵢ]=vᵢñᵢ−ñᵢΣⱼS_{i,j}ñⱼ−tᵢ|nᵢ| (15)

Consequently, as expressed in block 1506, F[{ñ}] can be maximized by maximizing each fᵢ[ñ] independently, that is, by finding the value of ñᵢ that yields the largest value of fᵢ[ñᵢ]. In view of the investor rule shown in EQ. 8, there are up to three potential values of ñᵢ^{k} that maximize fᵢ as shown below in EQ. 16.

$${\tilde{n}}_{i}^{k} = \{ \begin{matrix}{\tilde{n}}_{i}^{min} , & k = 1 \\ 0 , & k = 2 \\ {\tilde{n}}_{i}^{max} , & k = 3\end{matrix} \qquad ( 16 )$$

For each asset i, the value of k is selected that maximizes fᵢ. This is expressed mathematically as k*=k: max fᵢ[ñᵢ^{k}]. The value of ñᵢ that yields the largest value of fᵢ[ñᵢ] can consequently be expressed as ñᵢ*=ñᵢ^{k}*.

In certain embodiments, it is desirable to verify that the calculated asset set {ñ*} does not violate the portfolio rebalance constraint, as shown in block 1509. Accordingly, a value for G*[{ñ*}], the value of the portfolio rebalance constraint for the set of assets {ñ}, can be calculated according to EQ. 17 and EQ. 18.

$${G}^{*} [ \{ {\tilde{n}}^{*} \} ] = {\sum }_{i} {g}_{i}^{*} [ {\tilde{n}}_{i}^{*} ] \qquad ( 17 )$$

where

g*ᵢ[ñ*ᵢ]=pᵢñ*ᵢ+tᵢ|ñ*ᵢ| (18)

If G*≦0, then the portfolio rebalance constraint is satisfied. Thus, as shown in block 1527, {ñ*} represents a set of assets with the largest possible net expected return subject to certain investor rules that also satisfies the portfolio rebalance constraint. In certain embodiments, the asset allocation n*ᵢ=ñ*ᵢ+nᵢ^{o} can be reported to the investor, and the process is terminated. However, in certain embodiments, further processing is conducted, as described herein.

If G*>0, then in certain embodiments, another technique for calculating net expected returns can be implemented. For example, as shown in block 1512, it is possible to define a Lagrangian function as shown in EQ. 19, that includes the Lagrange multiplier γ.

H[{n}]=F[{n}]+γG[{n}] (19)

A solution that maximizes the value of H[{ñ}] with respect to can improve the net expected return F[{ñ}] and satisfy the portfolio rebalance constraint G[{ñ}].

The Lagrangian function is piecewise linear with respect to ñᵢ, and accordingly the expression for H[{ñ}] can also be expressed in the form shown in EQ. 20, below. H[{ñ}] can be maximized with respect to {ñ} by maximizing each hᵢ{ñᵢ] independently. The piecewise linear Lagrangian shown in EQ. 19 and EQ. 20 permits each asset to be processed independently by decoupling asset-asset interactions in the objective function and/or constraints.

$$H [ \{ \tilde{n} \} ] = {\sum }_{i} {h}_{i} [ {\tilde{n}}_{i} ] \qquad ( 20 )$$

where

hᵢ[ñᵢ]=fᵢ[ñᵢ]+γᵢgᵢ[ñᵢ] (21)

$${f}_{i} [ {\tilde{n}}_{i} ] = {v}_{i} {\tilde{n}}_{i} - {\tilde{n}}_{i} {\sum }_{j} {S}_{i , j} {\tilde{n}}_{j}^{* , I} - {t}_{i} \vert {\tilde{n}}_{i} \vert \qquad ( 22 )$$

gᵢ[ñᵢ]=pᵢñᵢ+tᵢ|ñᵢ| (23)

In view of the investor rule shown in EQ. 8, there are up to three potential values of ñᵢ that maximize hᵢ[ñᵢ]: ñᵢ^{min}, 0, ñᵢ^{max}.

However, as γᵢ changes values, the value of ñᵢ that maximizes hᵢ[ñᵢ] (ñ*ᵢ) can also change. That is ñ*ⱼ is a function of γᵢ. This relationship can be expressed as shown below in the set of equations shown in EQ. 24 and also expressed in block 1512.

$$H [ γ ] = {\sum }_{i} {h}_{i}^{*} [ {γ}_{i} ] \\ {h}_{i}^{*} [ {γ}_{i} ] = {f}_{i} [ {n}_{i}^{*} [ {γ}_{i} ] ] + {γ}_{i} {g}_{i} [ {n}_{i}^{*} [ {γ}_{i} ] ] \qquad ( 24 )$$

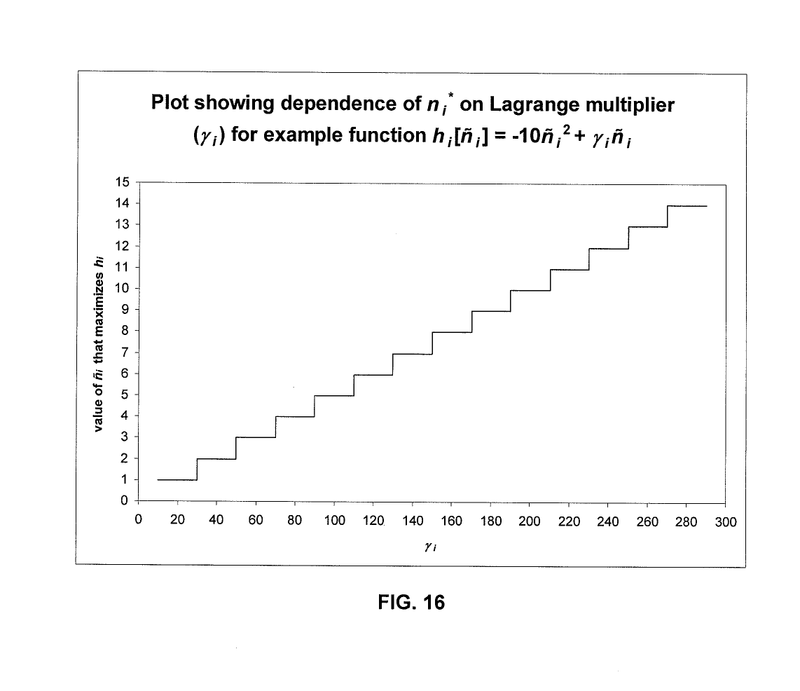

This relationship is further demonstrated in FIG. 16, which plots ñ*ᵢ as a function of γᵢ for the function hᵢ[ñᵢ]=−10ñᵢ²+γᵢñᵢ where ñᵢ is limited to integer values. As shown in the plot, certain values of γᵢ cause the solution ñ*ᵢ that maximizes hᵢ[ñᵢ] to transition from one value to another value.

Consequently, the values of both ñ*ᵢ and γᵢ are evaluated in certain embodiments. The value of γᵢ that minimizes hᵢ can be determined. In certain embodiments, a search method such as a bisection/binary-search method can be used on γᵢ to determine the value of γᵢ that minimizes hᵢ[γᵢ].

However, as shown in block 1515, in certain preferred embodiments, computational time for evaluating ñ*ᵢ and γᵢ can be saved by determining critical Lagrange multiplier values (“CLMV”) of γᵢ and performing a bisection method on the indices as opposed to γᵢ directly in order minimize hᵢ[γᵢ]. These techniques are described in more detail below.

As explained above, in certain embodiments, ñᵢ can be treated as a discrete variable. For example, the value of ñᵢ can be limited to integer values. Consequently, different values of γᵢ can give the same solution to the problem of maximizing hᵢ[ñᵢ].

For instance, an example function is defined as hᵢ[ñᵢ]=−10ñᵢ²+γᵢñᵢ, as shown in FIG. 16. It is desired to find the value of ñᵢ that maximizes the function hᵢ[ñᵢ], that is ñ*ᵢ. In the example above, all values of γᵢ from 110 to 130 result in ñ*ᵢ=6.

To find the value of γᵢ where ñ*ᵢ transitions from ñ*ᵢ=5 to ñ*ᵢ=6, it is possible to set hᵢ[ñᵢ=5]=hᵢ[ñᵢ=6] and solve for γᵢ. In this example, the solution is

$${γ}_{i} = \frac{10 ( {6}^{2} - {5}^{2} )}{( 6 - 5 )} = 110.$$

Applying the foregoing principles to EQ. 21, the following pseudocode demonstrates an example technique for calculating CLMV γᵢ^{α}, the values of γᵢ where the solution of ñᵢ that maximizes hᵢ[ñᵢ] transitions from one value of ñ*ᵢ to another.

| IF (ñᵢ^{min} = ñᵢ^{max}) THEN Kᵢ = 1 | |
|---|---|
| | ñᵢ¹ = ñᵢ^{min} |
| | γᵢ¹ = 0 |
| | γᵢ² = 0 |
| ELSE IF (ñᵢ^{max} ≦ 0 OR ñᵢ^{min} ≧ 0) THEN Kᵢ = 2 | |
| | ñᵢ¹ = ñᵢ^{min} |
| | ñᵢ² = ñᵢ^{max} |
| | γᵢ¹ = 0 |
| | ${γ}_{i}^{2} = \frac{{f}_{i} [ {\tilde{n}}_{i}^{1} ] - {f}_{i} [ {\tilde{n}}_{i}^{2} ]}{{g}_{i} [ {\tilde{n}}_{i}^{1} ] - {g}_{i} [ {\tilde{n}}_{i}^{2} ]}$ |
| ELSE Kᵢ = 3 | |
| | ñᵢ¹ = ñᵢ^{min} |
| | ñᵢ² = 0 |
| | ñᵢ³ = ñᵢ^{max} |
| | ${γ}_{i}^{1} = \frac{{f}_{i} [ {\tilde{n}}_{i}^{1} ] - {f}_{i} [ {\tilde{n}}_{i}^{2} ]}{{g}_{i} [ {\tilde{n}}_{i}^{1} ] - {g}_{i} [ {\tilde{n}}_{i}^{2} ]}$ |
| | ${γ}_{i}^{2} = \frac{{f}_{i} [ {\tilde{n}}_{i}^{2} ] - {f}_{i} [ {\tilde{n}}_{i}^{3} ]}{{g}_{i} [ {\tilde{n}}_{i}^{2} ] - {g}_{i} [ {\tilde{n}}_{i}^{3} ]}$ |

END IF

As explained in block 1518 of FIG. 15, in certain embodiments, the values of the critical Lagrange multipliers {γᵢ^{α}} are sorted in ascending order, duplicate values are eliminated, and the critical Lagrange multipliers are indexed from 1 to N creating the new ordered set of CLMV {γᵢ^{c}}.

By evaluating each asset independently, the value of the CLMV selected from the ordered set {γᵢ^{c}} can be determined that minimizes hᵢ, as shown in block 1521. The corresponding asset set {ñ*} can be established based on the calculated CLMV. This technique can be accomplished through the following pseudocode, which demonstrates a bisection technique for minimizing H[γ]. By focusing on the values of γᵢ that cause the solution of ñᵢ that maximizes hᵢ[ñᵢ] to transition from one value of ñ*ᵢ to another, the following method advantageously avoids wasting computational time calculating values of ñ*ᵢ and γᵢ that give the same value of hᵢ[ñᵢ].

FOR EACH ASSET i

IF (ñᵢ^{min} = ñᵢ^{max}) THEN Kᵢ = 1

ñᵢ¹ = ñᵢ^{min}
ñᵢ* = ñᵢ¹

ELSE IF (ñᵢ^{max} ≦ 0 OR ñᵢ^{min} ≧ 0) THEN Kᵢ = 2

ñᵢ¹ = ñᵢ^{min}
ñᵢ² = ñᵢ^{max}
FOR CLMV c = 1 to 2

IF (γᵢ^{c} < γᵢ²) THEN

ñᵢ^{c} = ñᵢ¹

ELSE

ñᵢ^{c} = ñᵢ²

END IF
hᵢ^{c} = fᵢ[ñᵢ^{c}] + γᵢ^{c}gᵢ[ñᵢ^{c}]

NEXT c
c* = c : min hᵢ^{c}
ñᵢ* = ñᵢ^{c}*

ELSE Kᵢ = 3

ñᵢ¹ = ñᵢ^{min}
ñᵢ² = 0
ñᵢ³ = ñᵢ^{max}
FOR CLMV c = 1 to 3

IF (γᵢ^{c} < γᵢ¹) THEN

ñᵢ^{c} = ñᵢ¹

ELSE IF (γᵢ¹ ≦ γᵢ^{c} < γᵢ²)THEN

ñᵢ^{c} = ñᵢ²

ELSE

ñᵢ^{c} = ñᵢ³

END IF
hᵢ^{c} = fᵢ[ñᵢ^{c}]+ γᵢ^{c}gᵢ[ñᵢ^{c}]

NEXT c
c* = c : min hᵢ^{c}
ñᵢ* = ñᵢ^{c}*

END IF

NEXT i

This method can consequently determine a set of assets {ñ*} that improves the net expected return of the portfolio asset allocation and also satisfies investment constraints, as shown in block 1524. In certain embodiments, the asset allocation n*ᵢ=ñ*ᵢ+nᵢ^{o} can be reported to the investor, and the process is terminated.

However, in certain embodiments, the set of assets {ñ*} returned in block 1524 can subsequently be iteratively refined. The processes described in blocks 1403 and 1406, shown in FIG. 14 and described above, can be repeated if the iteration counter I is less than some preset number of iterations I^{LS}. As described above in relation to EQ. 12, the current estimate for the solution for the Ith iteration, ñ*ⱼ′^{I}, is equivalent to the asset distribution ñ*ᵢ returned in block 1524 shown in FIG. 15.

In certain embodiments, it can be desirable to perform additional calculations on a set of assets that improves the net expected return of the portfolio asset allocation. For example, as shown in FIG. 14, it can be desirable to calculate an improved solution along the line joining a prior solution with a later solution.

Thus, as shown in block 1409, the vector connecting a new solution ñ*′^{I+1} to the previous solution ñ*′^{I} can be calculated according to the equation shown in EQ. 25.

uᵢ=ñ*ᵢ′^{I+1} (25)

A line search can be conducted to evaluate the net expected returns at points along the vector, as shown in block 1412. The line connecting the old solution to the new solution can be divided into M equally spaced points (l=1 to M) and each point can be evaluated according to the formula provided in EQ. 26.

$${\tilde{n}}_{i , l} = {\tilde{n}}_{i}^{* , I} + \frac{l}{M} {u}_{i} \qquad ( 26 )$$

The value of l that maximizes Fₗ (EQ. 27), that is l*, is determined. The iteration count I is incremented according to I=I+1, and the new estimate for the set of assets is defined as ñ*ᵢ′^{I}=ñᵢ^{l}*.

$${F}_{l} = {\sum }_{i} {v}_{i} {\tilde{n}}_{i , l} - {\sum }_{i , j} {\tilde{n}}_{i , l} {S}_{i , j} {\tilde{n}}_{j , l} - {\sum }_{i} {t}_{i} \vert {\tilde{n}}_{i , l} \vert \qquad ( 27 )$$

As explained above, in certain embodiments, the set of assets that improves the net return can be iteratively refined as shown in block 1415. For example, if I<I^{LS}, control is passed back to block 1403. Other techniques for determining whether to perform additional iterations can also be implemented. An example is measuring the relative or absolute change in the objective function with each iteration. If it is smaller than a user defined tolerance, then the solution has sufficiently converged and no additional iterations are performed.

In certain embodiments, the asset allocation n*ᵢ=ñ*ᵢ+nᵢ^{o} can be reported to the investor, and the process is terminated.

However, in certain embodiments, it can be desirable to “quantize” at least some of the set of assets that improves the net return of the portfolio. Quantizing the solution returns a set of whole numbers. It is often impossible to purchase or sell a fraction of a share of an asset, such as a stock. Consequently, it can be desirable to report the set of assets that improves the net return of the portfolio as a set of whole numbers.

In certain embodiments, quantizing can be instituted as an investor rule that serves as a process constraint. For example, an investor rule can be set as mod (nᵢ/1)=0. The modulo operation, commonly represented as “mod,” finds the remainder of division of one number by another. The example rule shown above requires that there is no remainder when nᵢ is divided by 1 (meaning that n, is a whole number). In certain embodiments, the quantization process can be performed after a set of assets has been calculated, for example, as shown in block 1524 of FIG. 15.

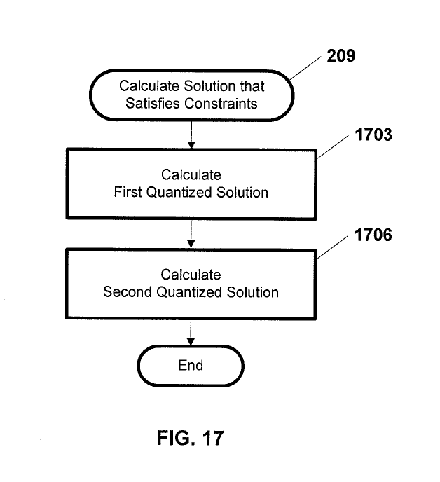

An example quantization process is shown in FIG. 17, comprising calculating a first quantized solution 1703 and calculating a second quantized solution 1706. The example embodiment of FIG. 17 shows the two processes performed in sequence. However, modifications can be made. For example, in certain embodiments only the first quantized solution 1703 is calculated.

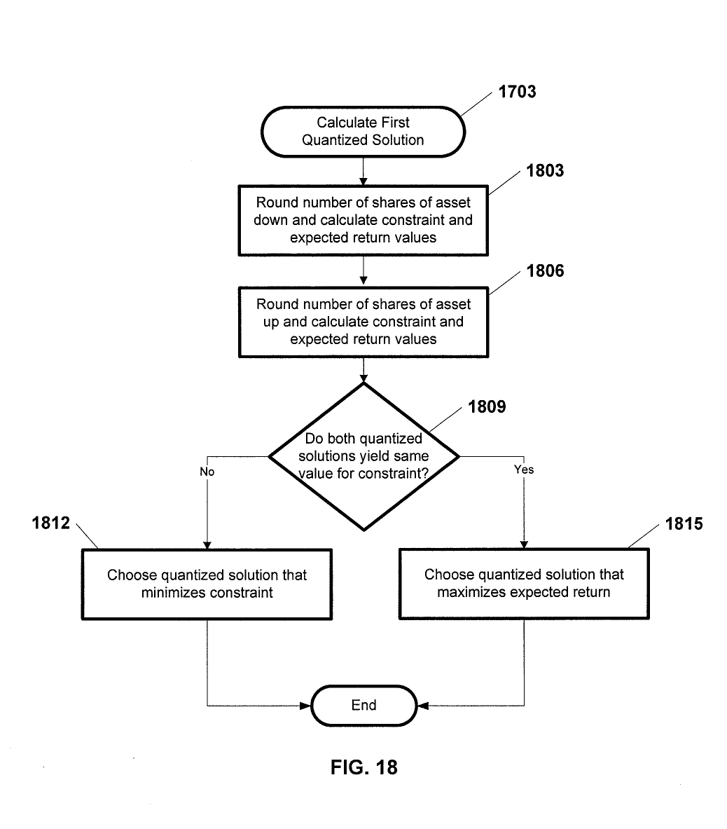

An example process of calculating first quantized solution is shown in more detail in FIG. 18. In this process, the values of ñᵢ are quantized so that the constraints are not violated. As shown in block 1803, values of gᵢ and fᵢ for each asset i are calculated by rounding down each ñᵢ using the floor function, as shown below in EQ. 28 through EQ. 30. As it is used here, the floor function of a real number x, denoted floor[x], is a function that returns the highest integer less than or equal to x. For example, floor[2.9]=2, floor[−2]=−2 and floor[−2.3]=−3.

ñᵢ^{a}=floor[ñ*ᵢ]

gᵢ^{a}=gᵢ[ñᵢ^{a}]

fᵢ^{a}=fᵢ[ñᵢ^{a}] (28)

where

gᵢ[ñᵢ^{a}]=pᵢñᵢ^{a}+tᵢ|ñᵢ^{a}| (29)

and

fᵢ[ñᵢ^{a}=vᵢñᵢ^{a}−ñᵢ^{a}ΣⱼS_{i,j}ñⱼ^{a}−tᵢ|nᵢ^{a}| (30)

As shown in block 1806, values of gᵢ and fᵢ for each asset i are also calculated by rounding up each ñᵢ using the ceil function, as shown in EQ. 31 through EQ. 33. As it is used here, the cell function of a real number x, denoted ceil[x], is the function that returns the smallest integer not less than x. For example, ceil[2.3]=3, ceil[2]=2 and cell[−2.3]=−2.

ñᵢ^{b}=ceil[ñ*ᵢ]

gᵢ^{b}=gᵢ[ñᵢ^{b}]

fᵢ^{b}=fᵢ[ñᵢ^{b}] (31)

where

gᵢ[ñᵢ^{b}]=pᵢñᵢ^{b}+tᵢ|ñᵢ^{b}| (32)

and

fᵢ[ñᵢ^{b}]=vᵢñᵢ^{b}−ñᵢ^{b}ΣⱼS_{i,j}ñⱼ^{b}−tᵢ|ñᵢ^{b}| (33)

As shown in block 1809, the value of gᵢ[ñᵢ^{a}] is compared with the value of gᵢ[ñᵢ^{b}]. If gᵢ[ñᵢ^{a}] is not equal to gᵢ[ñᵢ^{a}], then as shown in block 1812, the solution of ñᵢ^{a} or ñᵢ^{b} can be chosen that yields the lower value of gᵢ. The chosen solution (ñᵢ^{a} or ñᵢ^{b}) can be stored as ñ*ᵢ. If both ñᵢ^{a} and ñᵢ^{b} yield the same value for gᵢ, then as shown in block 1815, the solution of ñᵢ^{a} or ñᵢ^{b} can be chosen that gives the higher value of fᵢ. The chosen solution (ñᵢ^{a} or ñᵢ^{b}) can be stored as ñ*ᵢ. Alternative decisions can be used. For example, in certain embodiments, preference can always be given to the value that maximizes fᵢ.

In certain embodiments, a verification can performed to ensure that the portfolio rebalance constraint as shown in EQ. 34 and EQ. 35.

$$G = {\sum }_{i} {g}_{i} [ {\tilde{n}}_{i}^{*} ] \leq 0 \qquad ( 34 )$$

where

gᵢ[ñ*ᵢ]=pᵢñ*ᵢ+tᵢ|ñ*ᵢ| (35)

If the portfolio rebalance constraint shown in EQ. 34 is not satisfied, then no quantized solution satisfies the portfolio rebalance constraint. A notification can be returned to the user that the optimization problem did not converge on a solution.

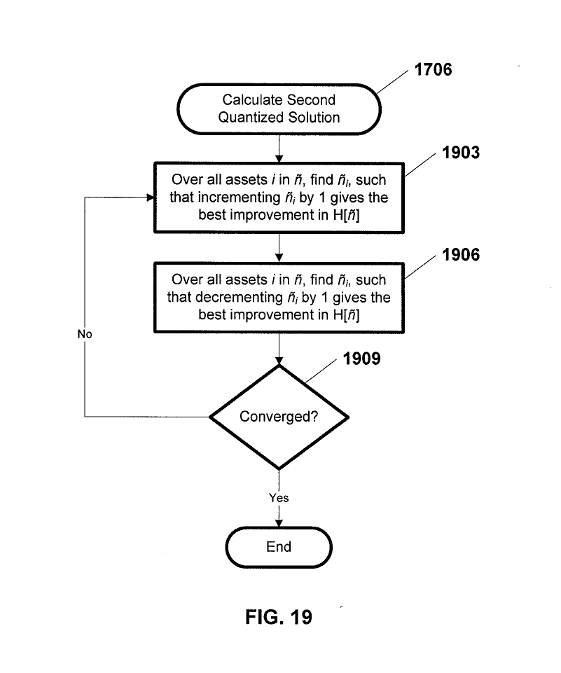

An example process of calculating second quantized solution is shown in more detail in FIG. 19. The process shown in FIG. 19 starts with an estimated solution ñ*, which is iteratively refined. The following procedure advantageously saves computational time saved by performing line searches going in the directions of the largest rates of improvement.

As shown in block 1903, the component i of the share vector ñ is identified such that incrementing only the ith component by 1 (that is, ñ*ᵢ=ñ*ᵢ+1) gives the largest increase in maximizing the objective function F+γ G while still within the bounds ñᵢ^{min}≦ñᵢ≦ñᵢ^{max} over any other component of the share vector ñ. The resulting value is stored as ñ*ᵢ=ñ*ᵢ+1.

As shown in block 1906, the component i of the share vector ñ is identified such that decrementing only the ith component by 1 (that is, ñ*ᵢ=ñ*ᵢ−1) gives the largest increase in maximizing the objective function F+γ G while still within the bounds ñᵢ^{min}≦ñᵢ≦ñᵢ^{max} over any other component of the share vector ñ. The resulting value is stored as ñ*ᵢ=ñ*ᵢ−1.

As shown in block 1909, if the process has not yet converged (for example, if the process has not yet completed I^{Q} iterations), then the processes of blocks 1903 and 1906 can be repeated. As discussed above, I^{Q} is part of the input data defined by the investor. If I^{Q} iterations have been completed, the asset allocation n*ᵢ=ñ*ᵢ+nᵢ^{o} can be reported and the process is terminated.

After an asset allocation {n*} is reported, the investor can be optionally directed to a trade execution process. One approach for trade execution is permitting the investor to direct himself or herself to a selected brokerage for implementing the asset allocation and associated trade orders.

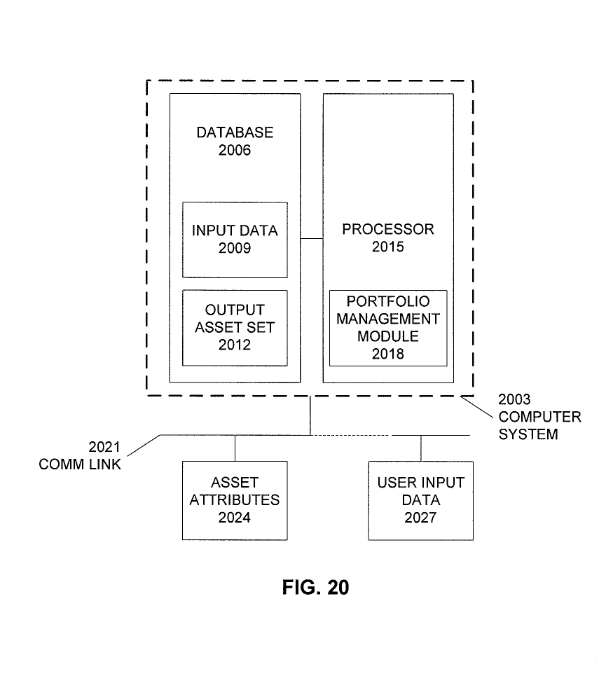

As shown in FIG. 20, the system can be hosted on at least one computer system 2003. In one embodiment, the computer system 2003 is a computer which is equipped with a modem. In certain embodiments, the computer system 2003 includes a device that allows the investor to interact with the system, by way of example a computer workstation, a local or wide area network of individual computers, a kiosk, a point-of-sale device, a personal digital assistant, an interactive wireless communications device, an interactive television, a transponder, or the like.

The computer 2003 comprises, by way of example, a processor 2015 representing data and instructions. In certain embodiments, the processor 2015 can comprise controller circuitry, processor circuitry, processors, general purpose single-chip or multi-chip microprocessors, digital signal processors, embedded microprocessors, microcontrollers and the like.

A portfolio management module 2018 can advantageously be configured to execute at least some of the disclosed calculations on the processor 2015. The portfolio management module 2018 can comprise, but is not limited to, any of the following: software or hardware components such as software object-oriented software components, class components and task components, processes methods, functions, attributes, procedures, subroutines, segments of program code, drivers, firmware, microcode, circuitry, data, databases, data structures, tables, arrays, or variables.

The computer 2003 receives data including asset attributes 2021 and user information data 2027 through a communication link 2021. Focusing now on the communication link 2021, in one embodiment, the communications link 2021 is the Internet, which is a global network of computers. In other embodiments, the communications link 2021 can be any communication system including by way of example, dedicated communication lines, telephone networks, wireless data transmission systems, two-way cable systems, customized computer networks, interactive kiosk networks, automatic teller machine networks, interactive television networks, and the like. The software of the management system can, in certain embodiments, be executed on one or more servers. The servers can communicate over a communication network with client devices such as, for example, a personal computer or PDA. The communication networks can be, for example, the Internet, a mobile phone network, or a local or wide area network. The servers of the management system can execute various modules of software to implement one or more of the functions described above. The software modules can, for example, be distributed across multiple servers.

The computer 2003 further comprises, by way of example, a database 2006 representing a structured collection of data. At least some of the asset attribute data 2021 and user input data 2012 can be stored in the database as input data 2009. The database 2006 can further store at least one output asset set 2021.

In certain embodiments, a distributed computational architecture can be used whereby the investor interfaces with a web server via an Internet browsing program executed on the investor's computer (e.g., Safari, Opera, Firefox, or Internet Explorer). The system can comprise a web server, an investment services server, an application server, a database server, and/or one or more scientific-computation processing servers.

In certain embodiments, a distributed data and computational architecture can be used. The investor can interface with a web server via an Internet browsing program executed on the investor's computer. The system can comprise the web server, an investment services server, an application server, and one or more scientific-computation processing servers having database capabilities. All or portions of the management system can run in a secure data center. At least some of the management system can optionally be provided as a web or local service to investors. The management system can, for example, be developed using a distributed, component-based architecture that can be scaled to accommodate a large number of sessions per day.

While certain embodiments of the inventions have been described, these embodiments have been presented by way of example only, and are not intended to limit the scope of the inventions. Indeed, the novel methods and systems described herein can be embodied in a variety of other forms. For example, although described primarily in the context of financial assets above (e.g., stocks), the above system can be used to manage other intangible (e.g., intellectual property), real (e.g., land) and/or tangible assets (e.g., commercial airplane leases). Therefore, such adaptations and modifications are within the meaning and range of equivalents of the disclosed embodiments. The phraseology or terminology employed herein is for the purpose of description and not of limitation. Furthermore, various omissions, substitutions and changes in the form of the methods and systems described herein can be made without departing from the spirit of the inventions. The accompanying claims and their equivalents are intended to cover such forms or modifications as would fall within the scope and spirit of the inventions.

What is claimed is:

1. In a computer system, a method of determining an allocation of assets in a financial portfolio selected from a plurality of assets available to buy or sell, the method comprising:
receiving at least one portfolio constraint comprising a limitation on the extent that assets can be allocated in the portfolio;
with the net expected returns of the assets, the at least one portfolio constraint, and at least one Lagrange multiplier, determining a function for each asset that allows its allocation to be determined independently of other assets.

2. The method of claim 1, wherein the portfolio constraint comprises a limitation that costs of executing recommended trades do not exceed benefits received from executing recommended trades.

3. The method of claim 1, wherein the portfolio constraint comprises a limitation on a quantity of at least one asset in the portfolio.

4. The method of claim 1, wherein the net expected returns comprises trading costs.

5. The method of claim 1, wherein the net expected returns comprises at least one quantitative measure of a financial or thematic investment strategy.

6. The method of claim 1, further comprising:
receiving a first allocation of assets selected from the plurality of assets that are available to purchase or sell; and
with the first allocation of assets, decoupling one or more correlations between assets in the net expected returns.

7. The method of claim 6, wherein the first allocation of assets is the allocation of assets determined in a prior iteration.

8. The method of claim 6, comprising decoupling risk correlations between assets in the net expected returns.

9. The method of claim 1, further comprising:
determining a set of one or more Lagrange multipliers that cause the allocation of the asset that corresponds to the Lagrange multiplier to change from one value to another value;
from the set of one or more Lagrange multipliers, selecting the Lagrange multiplier and the corresponding asset allocation that give the best improvement in the function's value.

10. The method of claim 1, further comprising recalculating the allocation of at least one asset in the portfolio to change the allocation from a real number comprising a fractional part to an integer value.

11. A computer system comprising:
a database configured to store input data comprising assets available to buy or sell and configured to store an output allocation of the assets;
at least one processor configured to receive the input data and calculate net expected returns of the assets and a portfolio constraint comprising at least one limitation on the extent that assets can be allocated;
a portfolio management module configured to determine the output allocation by independently processing each asset in the plurality of assets and selecting a value of a Lagrange multiplier and a corresponding asset allocation that improves net expected returns and enforces the constraint.

12. The system of claim 11, wherein the portfolio constraint comprises a limitation that costs of executing trades do not exceed benefits of executing trades.

13. The system of claim 11, wherein the portfolio constraint comprises a limitation on a quantity of at least one asset allocation.

14. The system of claim 11, wherein the input data and the net expected returns comprises trading costs.

15. The system of claim 11, wherein the input data and the net expected returns comprises at least one quantitative measure of a financial or thematic investment strategy.

16. The system of claim 11, wherein the at least one processor is further configured to receive the output allocation of the assets and with the output allocation, decouple one or more correlations between assets in the net expected returns.

17. The system of claim 16, wherein the at least one processor is configured to decouple risk correlations between assets in the net expected returns.

18. The system of claim 11, wherein the portfolio management module is further configured to determine a set of one or more Lagrange multipliers that cause the allocation of the asset that corresponds to the Lagrange multiplier to change from one value to another value.

19. The system of claim 11, wherein the portfolio management module is further configured to recalculate at least a portion of the allocation of assets to change real numbers comprising a fractional part to integer values.
